(19) United States
(12) Patent Application Publication
(10) Pub. No.: US 2023/0002271 A1
(43) Pub. Date: Jan. 5, 2023

(54) PRODUCT COMPRISING A TRANSPARENT, VOLUME-COLOURED GLASS-CERAMIC

(71) Applicant: SCHOTT AG, Mainz (DE)

(72) Inventors: Evelin Weiss, Mainz (DE); Klaus Schönberger, Mainz (DE); Johannes Stinner, Mainz (DE); Matthias Bockmeyer, Mainz (DE); Philipp Langer, Alsheim (DE); Reiner Best, Albig (DE)

(73) Assignee: SCHOTT AG, Mainz (DE)

(21) Appl. No.: 17/853,851

(22) Filed: Jun. 29, 2022

(30) Foreign Application Priority Data
Jun. 29, 2021 (EP) 21401028.2

(51) Int. Cl. C03C 10/00; C03C 4/02

(52) U.S. Cl. CPC C03C 10/0027; C03C 4/02; C03C 2204/00

(57) ABSTRACT

A product having a transparent volume-coloured glass-ceramic is provided. The glass-ceramic includes, based on oxide, 58-72% by weight SiO₂, 16-26% by weight Al₂O₃, 1.0-5.5% by weight Li₂O, 2.0-<4.0% by weight TiO₂, 0-<2.0 by weight ZnO, and 0.005-0.12% by weight MoO₃, and where the glass-ceramic, based on a thickness of 4 mm, has a luminous transmittance τᵥᵢₛ of 0.5%-3.5%, and where the glass-ceramic has the property that after passage through the glass-ceramic, based on a thickness of 4 mm, light of the standard illuminant D65 has a colour locus in the white region A1 that in the CIExyY-2° chromaticity diagram is defined by the following coordinates:

A1

| | |
|---|---|
| 0.3 | 0.27 |
| 0.28 | 0.315 |
| 0.35 | 0.38 |
| 0.342 | 0.31 |
| 0.3 | 0.27. |

### CROSS REFERENCE TO RELATED APPLICATIONS

This application claims benefit under 35 USC § 119 of European Application 21401028.2 filed Jun. 29, 2021, the entire contents of which are incorporated herein by reference.

### BACKGROUND

### 1. Field of the Invention

The invention relates to a product featuring a transparent, volume-coloured glass-ceramic, and also to its use.

### 2. Description of Related Art

Products featuring a transparent, volume-coloured glass-ceramic are diversely employed for example in furnishings and fittings for kitchens and laboratories. Sheets of glass-ceramic are used for example as viewing windows in doors of baking ovens, as a cover panel for operating elements of cooking appliances, or as a worktop on a kitchen cupboard or laboratory furnishing, and also in both the household and professional spheres. Such articles frequently also have lighting systems comprising multiple luminous elements, provided for example for the purpose of showing an operating state or for decorative lighting, by shining through the glass-ceramic sheet.

Especially for lighting systems which are part of a user interface on such an article, the technical requirements are becoming ever more complex. The key point in such cases is always to facilitate operation of the article for the user and to increase operation safety. At the same time, the glass-ceramic sheets employed for this purpose are to have maximum versatility, allowing them to be combined with almost any conceivable type of lighting system.

Examples of complex requirements of this kind imposed on lighting systems for user interfaces are the use of multiple light colours for representing difference functions, in which case all of the colours must be able to be represented with high brightness. Preferred for this purpose in particular are blue, red and white light.

Another example is the establishment of the illumination at different brightnesses, in order, for example, to emphasise activated parts of the user interface relative to non-activated parts, for interaction with the user. In such a case, for example, active parts may be represented more brightly than non-activated parts.

At the same time the glass-ceramic products must meet the rest of the requirements for the use in question, examples being thermal, chemical and mechanical integrity or opacity for preventing the interior of an article being viewed.

Known from the prior art are, for example, transparent, volume-coloured glass-ceramics, as a cover plate for cooking appliances. Volume-coloured glass-ceramic plates for cooking appliances generally include vanadium ions for colouring, as these ions possess the particular property of absorbing in the region of visible light and exhibiting high transmission in the region of infrared radiation. Coloration of this kind by means of V₂O₅ is known from DE 10 2008 050 263 A1, for example.

The increase in the transmission of glass-ceramics volume-coloured by means of vanadium begins right in the red part of the visible spectral range, and not only in the near-infrared. For red light, therefore, they have a transmission which is higher by a multiple than for blue light, for example.

Available on the market are a number of variants of transparent, volume-coloured glass-ceramics for cooking appliances, which in terms of their optical properties can be divided into two categories.

The darker glass-ceramic plates at a thickness of 4 mm of a luminous transmittance of around 0.5%-3.5%. On account of the low light transmittance, these plates effectively prevent the hob interior being viewed.

The lighter glass-ceramic plates at a thickness of 4 mm have a luminous transmittance of around 3.5%-6%. Because of the higher light transmittance, glass-ceramic plates of this kind must generally be provided with opaque layers on the underside in order to prevent the hob interior being viewed. Because of the higher transmission overall, they are suitable in principle for use with red and blue lighting systems. However, they are not automatically compatible with the lighting systems for the darker glass-ceramic plates, as these would appear too bright and in the worst case might reduce operational safety because of a blinding effect.

It is also known from the prior art that glass-ceramic plates of these kinds can be combined with colour compensation filters in order to enable the use of white lighting systems as well. Generally speaking, however, such optical filters have only limited temperature stability and are relatively expensive.

DE 20 2018 102 537 U1 discloses furniture and equipment articles featuring transparent, volume-coloured glass-ceramic substrates. The main colorant of the glass-ceramics is MoO₃ and they have a luminous transmittance of between 0.1% and 12%. The colour locus of the glass-ceramics extends in the CIEyxY colour space along the black-body curve within a white region W1.

### SUMMARY

It is an object of the present invention to provide a product comprising a volume-colour transparent glass-ceramic, with the colour locus of the glass-ceramic being particularly colour-neutral. At the same time the economics are to be improved relative to the glass-ceramics known from the prior art.

The invention relates accordingly to a product comprising a transparent volume-coloured glass-ceramic, where the glass-ceramic comprises the following constituents in % by weight based on oxide: SiO2 58-72, Al₂O₃ 16-26, Li₂O 1.0-5.5, TiO₂ 2.0-<4.0, ZnO 0-<2.0, MoO₃ 0.005-0.12, where the glass-ceramic, based on a thickness of 4 mm, has a luminous transmittance τᵥᵢₛ of 0.5%-3.5%, and where the glass-ceramic has the property that after passage through the glass-ceramic, based on a thickness 4 mm, light of the standard illuminant D65 has a colour locus in the white region A1 that in the CIExyY-2° chromaticity diagram is defined by the following coordinates:

A1

| | |
|---|---|
| 0.3 | 0.27 |
| 0.28 | 0.315 |
| 0.35 | 0.38 |
| 0.342 | 0.31 |
| 0.3 | 0.27 |

A product of this kind may be, for example, an article of furnishing or equipment for a kitchen or a laboratory. For the purposes of the present invention this means in general an article suitable for furnishing or equipping a kitchen or a laboratory. These are, more particularly, kitchen or laboratory furnishings or kitchen or laboratory appliances, which preferably are operated electrically, irrespective of their specific construction form. Kitchen or laboratory furniture includes, in particular, cupboards and benches which have a worktop on their upper side. Kitchen appliances such as cooking appliances, refrigerators, microwave appliances, grills, baking ovens, steam cookers, toasters or extractor hoods here may be designed either for the household or for the professional sphere. The article may also be a separate operating panel via which a user is able to operate one or more appliances controllable with the panel. Appliances of the invention may be amenable to integration into kitchen or laboratory furniture, for example, or may be free-standing. The laboratory appliances include, among others, ovens, air-conditioned cabinets, refrigerators or hotplates.

The product may also be a stove, more particularly a stove window, and internal lining for a stove, a heat lamp, more particularly a cover or an infrared heat lamp, a mobile electronic device such as a mobile phone or a tablet computer, or a motor vehicle, more particularly an operating or display panel in a motor vehicle, or may comprise fire protection glazing.

Another example of a product of the invention is a hob having a glass-ceramic cooking plate, said hob comprising a display device and also, for example, heating elements, more particularly induction heating elements. Viewing windows in baking-oven doors or microwave doors also represent products of the invention. In kitchen or laboratory furniture, such products may represent at least part of the body of the furniture or the front, a door or a drawer. With particular preference a product as a cover plate constitutes part or even the entire worktop of a kitchen or laboratory furniture item.

A product of the invention comprises a transparent, volume-colour glass-ceramic. A transparent glass-ceramic here is a glass-ceramic exhibiting low scattering of visible light. A volume-colour glass-ceramic in the sense of the present invention is a glass-ceramic which has a luminous transmittance of less than 80% and comprises as colouring constitutes single or multiple oxides of the transition metals of groups 5 to 11 of the Periodic Table of the Elements. This include, in particular, V₂O₅, Cr₂O₃, Fe₂O₃, CoO, NiO, CuO and MoO₃. Certain other chemical elements may also act to colour the glass-ceramic, examples being oxides of lanthanoids, more particularly Nd₂O₃. As a result of these colouring constitutes, the glass-ceramic absorbs light. On the basis of this absorption, the luminous transmittance is less than 80%. Owing to the operation by which glass-ceramics are produced, the constitutes are distributed substantially homogeneously in the glass-ceramic. The colouring constitutes therefore result in homogeneous colouration in the volume of the glass-ceramic.

This distinguishes the transparent, volume-coloured glass-ceramics from the opaque glass-ceramics which because of substantial scattering of visible light exhibit reduced light transmission. The light scattering of opaque glass-ceramics is a result of the number, size and refractive index of the crystals within the glass-ceramic. It is therefore a consequence of the microstructure of the glass-ceramic.

The transparent, volume-coloured glass-ceramics also differ from the transparent, uncoloured glass-ceramics in that they have a lower luminous transmittance. Uncoloured glass-ceramics have a luminous transmittance of more than 80%. They contain colouring constitutes either only as an unavoidable impurity, on the basis of the raw materials used for their production, or only in very small amounts, for fine-tuning optical properties of the transparent, uncoloured glass-ceramic.

The glass-ceramic of the product of the invention comprises 58%-72% by weight of SiO₂, 16%-26% by weight of Al₂O₃ and 1.0%-5.5% by weight of Li₂O. These three components are absolutely necessary in these amounts in order to allow the microstructure typical of a lithium aluminium silicate glass-ceramic to be established, with the associated low thermal expansion.

The glass-ceramic of the product of the invention preferably comprises 60%-70% by weight of SiO₂, 18%-24% by weight of Al₂O₃ and 2.5%-5% by weight of Li₂O. More preferably the glass-ceramic of the product of the invention comprises 62%-68% by weight of SiO₂, 19%-23% by weight of Al₂O₃ and 3%-4.5% by weight of Li₂O. Within these preferred limits, the typical microstructure and hence the low thermal expansion can be established particularly easily and with particular stability in industrial production.

The Li₂O fraction in particular as a great influence on the thermal expansion of the glass-ceramic, since Li₂O is one of the essential constitutes of the crystalline phase of the glass-ceramic. The less Li₂O there is, the lower the volume fraction of crystalline phase in the glass-ceramic. The result of this is greater thermal expansion. At the same time lithium is a strategic critical raw material for the production of the glass-ceramic. The high demand for lithium for battery manufacturer greatly influences the amount of available lithium and its price. For products which are required to meet less stringent requirements with regard to thermal cycling stability, therefore, it is advantageous to use glass-ceramics with as low an Li₂O fraction as possible, more particularly with an Li₂O fraction in the range 1.2%-3%, preferably 1.3%-2.5% or even 1.5%-2%.

The glass-ceramic of the product of the invention additionally comprises 2.0%-<4.0% by weight of TiO₂, 0%-<2.0% by weight of ZnO and 0.005%-0.12% by weight of MoO₃.

TiO₂ has a great influence on the nucleation during ceramisation. It therefore plays as important part during the production of the glass-ceramic. Since the colour effect of the molybdenum oxide is also supported in the amounts according to the invention—that is, the addition of TiO₂ in the presence of MoO₃ leads to lower light transmission values, the invention requires a minimum level of 2.0% by weight in glass-ceramic. A minimum level of 2.5% by weight of preferred, more preferably of 2.8% by weight or even of 3.0% by weight. The TiO₂, however, has an adverse effect on devitrification stability. The amount of TiO₂ is consequently less than 4.0% by weight. In order to improve further the devitrification stability, the amount of TiO₂ is preferably not more than 3.9% by weight or even not more than 3.8% by weight. In one preferred embodiment, therefore, as well as the other constitutes, the glass-ceramic contains TiO₂ in amounts of 2.5%-<4.0% by weight, preferably 2.8%-3.9% by weight, more preferably 3.0%-3.8% by weight.

It has surprisingly emerged that in the production of MoO₃-containing glass-ceramics in continuous commercial melting units, ZnO has a particularly strong influence both on the resulting microstructure and on the colouring of the glass-ceramic.

In accordance with the invention, therefore, the ZnO content of the glass-ceramic is strictly limited to less than 2% by weight, preferably at most 1.9% by weight, more preferably at most 1.8% by weight. In small amounts, however, ZnO supports the development of a glass-ceramic microstructure which is particularly advantageous for the invention. There is therefore preferably at least 0.1% by weight, more preferably at least 0.5% by weight, more particularly at least 1.0% by weight or even at least 1.2% by weight of ZnO in the glass-ceramic.

The product of the invention is further characterized in that in combination with the components stated above, the glass-ceramic contains MoO₃ in amounts of 0.005% to 0.12% by weight. In one development of the invention, the glass-ceramic contains 0.015%-0.100% by weight, preferably 0.020%-0.080% by weight, more preferably 0.030%-0.070% by weight. Since different valences of the Mo atom may be represented in the glass-ceramic, the specified contents in the composition are based, for analytical purposes, on the compound MoO₃.

A minimum level of 0.005% by weight of MoO₃, in combination with the other components in the respective amounts, leads to the required colour effect and transmission being obtained. If the aim is to establish a low light transmission, higher MoO₃ levels, of up to 0.12% by weight, are required. Similarly, if Fe₂O₃ or V₂O₅ is added, then higher MoO₃ levels up to 0.12% by weight tend to be necessary, since both Fe₂O₃ and V₂O₅ modify the transmission characteristics of the glass-ceramic in such a way that the colour locus of light of standard illuminant D65 after passage through the glass-ceramic, is shifted away from the black-body curve, more particularly towards red hues. This effect can be at least partly compensated by the addition of MoO₃.

In quantities of up to 0.12% by weight or less, the MoO₃, more particularly the reduced molybdenum oxide species, exhibit substantially no nucleator effect and therefore have no significant influence on the devitrification stability.

In order to establish the colour effect, there is preferably at least 0.015% by weight, more preferably at least 0.020% by weight and very preferably at least 0.030% by weight of MoO₃ present. As an upper limit the MoO₃ content is preferably 0.100% by weight, more preferably 0.080% by weight, very preferably 0.070% by weight.

A particularly precisely established luminous transmittance can be achieved in particular using particularly little MoO₃ if the ratio of MoO₃ to TiO₂, i.e. MoO₃/TiO₂, is between 0.002 and 0.050, preferably between 0.004 and 0.040, more preferably between 0.008 and 0.030.

The glass-ceramic of the product of the invention, moreover, based on a thickness of 4 mm, has a luminous transmittance τᵥᵢₛ of 0.5%-3.5%, preferably 0.8%-3.2%, more preferably 1.0%-3.0%, more particularly 1.2%-2.8%.

The luminous transmittance τᵥᵢₛ refers to the degree of light transmission measured in the visible spectral range from 380 to 780 nm in accordance with DIN EN 410. The value is a measure of the sensitivity of the human eye to the light. The value is identical to the brightness Y in the CIExyY colour space, measured in transmission.

“Based on a thickness of 4 mm”, here means that the value is measured preferably for a glass-ceramic thickness of 4 mm. If the glass-ceramic has a thickness other than 4 mm, the transmission spectrum of the glass-ceramic with the existing thickness is measured and is converted for a thickness of 4 mm by means of the Beer-Lambert law. The luminous transmittance is then determined in accordance with DIN EN 410 using this spectrum converted for 4 mm.

The glass-ceramic of the product is transparent. It therefore has negligible scattering for visible light. For the outcome of the measurement, therefore, it is immaterial whether an Ulbricht sphere is used for measuring the transmission, or whether measurement takes place only from an observation angle of 2°. The diffusely transmitted fraction is negligibly small relative to the directly transmitted fraction. The values measured for the luminous transmittance of the base body with and without Ulbricht sphere therefore differ at most by 10%, preferably at most 1% or even by less than 0.5%, based on the value measured with Ulbricht sphere.

A glass-ceramic having a luminous transmittance τᵥᵢₛ of 0.5-3.5% based on a thickness of 4 mm has stronger or weaker opacity under normal ambient light, depending on its actual thickness. Normal ambient light includes, for example, daylight or illumination with a brightness similar to that of daylight. At the same time, however, the glass-ceramic is sufficiently light to allow luminous displays to be perceived through the glass-ceramic with appropriate brightness.

With particular advantage this makes it possible to provide products having a user interface which has at least one luminous display. Luminous display of this kind is in this case visible through the glass-ceramic when it is switched on, but invisible when it is not in operation. This is particularly advantageous, for example, for cooking surfaces in which displays are to be visible only when the cooking appliance or the respective display is in operation. This increases operating safety and hence the operational reliability of the cooking appliance, since incorrect settings of the cooking appliance can be produced.

For cooking surfaces, for example, the glass-ceramic typically has a thickness of between 3 and 7 mm. In general the thickness for cooking surfaces is approximately 4 mm or approximately 6 mm.

The glass-ceramic of the product of the invention has the property that after passage through the glass-ceramic, based on a thickness of 4 mm, light of the standard illuminant D65 has a colour locus in the white region A1 which in the CIExyY-2° chromaticity diagram is defined by the following coordinates:

A1

| x | y |
|---|---|
| 0.3 | 0.27 |
| 0.28 | 0.315 |
| 0.35 | 0.38 |
| 0.342 | 0.31 |
| 0.3 | 0.27 |

Light of the standard illuminant D65 has by definition a colour temperature of around 6500 K and when viewed direct by a 2° observer has a colour locus of x=0.3127 and y=0.3290.

A glass-ceramic having the property that light of the standard illuminant D65 after passing through this glass-ceramic has a colour locus of x=0.3127 and y=0.3290 is perfectly colour-neutral. It does not change the colour of light passing through it. The colour shift

C*=\sqrt{(x₁−x₂)²+(y₁−y₂)²}

is in this case C*=0. Here, x₁ and y₁ are the colour coordinates of the light on direct viewing of the light source (without glass-ceramic), and x₂ and y_{z} are the colour coordinates of the light when the light source is viewed through the glass-ceramic.

In so far as the term “light” is not otherwise elucidated or specified, it always refers to visible light in the 380 nm to 780 nm wavelength range.

All glass-ceramics of the product of the invention have particularly high colour neutrality, as they generate a colour shift of C*≤0.08 for light of the standard illuminant D65. The white region A1 is therefore notable for particularly high colour neutrality of the glass-ceramics contained therein.

The white region A1 here is a region along the black-body curve in the CIExyY colour space that ranges from around 4500 K to around 9000 K colour temperature and is shifted upward at the upper boundary by a value of around y=0.03 relative to the black-body curve, and shifted downward at the lower boundary by around y=0.04. With the present invention, therefore, when white light passes through the glass-ceramic, the colour locus of the light can be shifted essentially along the black-body curve, both toward higher colour temperatures (e.g. 6500 K→9000 K) and toward lower colour temperatures (e.g. 6500 K→4500 K) without generated an unwanted tint. White light is therefore still perceived as white light even after it has passed through.

The colour locus of light can be measured, for example, with the CS-150 colorimeter from Konica Minolta. It is likewise possible to measure the transmission spectrum of the glass-ceramic and to use it, with the aid of the known spectrum of D65 standard light and the visual sensitivity of a 2° standard observer, in accordance with the specifications of the CIE, to calculate the colour locus.

In one preferred embodiment the glass-ceramic of the product has the property that after passage through the glass-ceramic, based on a thickness of 4 mm, light of the standard illuminant D65 has a colour locus in the white region A2 which in the CIExyY-2° degree chromaticity diagram is defined by the following coordinates:

A2

| x | y |
|---|---|
| 0.290 | 0.315 |
| 0.345 | 0.370 |
| 0.341 | 0.320 |
| 0.303 | 0.283 |
| 0.290 | 0.315 |

All glass-ceramics having this property are notable for even colour neutrality, since for light of the standard illuminant D65 they generate a colour shift of only C*≤0.05. Moreover, after passing through a preferred glass-ceramic of this kind, white light is located particularly close to the black-body curve and is therefore perceived by the human eye to be particularly white.

A further property of a glass-ceramic is the amount of oxygen which is present in the glass-ceramic in the form of dissolved oxygen, i.e. oxygen not bonded covalently into the glass matrix. The amount of dissolved oxygen results from the melting process used for production. It can be influenced in a variety of ways. For example, higher melting and refining temperatures lead to less oxygen in the glass-ceramic. At higher temperatures the glass melt has a lower viscosity, and so the gas bubbles which form are able to escape more easily from the glass-ceramic.

The oxygen content may also be influenced by the nature and amount of the refining agent or by the addition of reducing agents. The reducing agents include, for example, readily oxidizable metals, sulfides or carbon, more particularly Al or Si powders, sugar, charcoal, SiC, TiC, MgS or ZnS. They are oxidized in the melt and consequently removed free of oxygen from said melt. The result is a glass-ceramic having a relatively low dissolved oxygen content.

The amount of dissolved oxygen in a glass-ceramic can be conventionally determined electrochemically. This is described comprehensively for example in the publication “Entwicklung einer Sonde zur Messung des Sauerstoffpartialdrucks in Glasschmelzwannen” [Developing a Probe for Measuring Oxygen Partial Pressure in Glass-melting tanks], Frey, T.; Schaeffer, H. A.; Baucke, F. G. in Glastechnische Berichte; 53, 5; 116-123, 1980. In short, shards of the glass-ceramic are first of all melted in a suitable vessel. Then temperature-stable measuring electrodes, composed for example of platinum, and a solid electrolyte with high conductivity for oxygen ions but low conductivity for electrons, made of yttrium-stabilised ZrO₂, for example, are introduced into the melt. Then, using the electrodes, the oxygen partial pressure is determined as a function of the temperature of the molten glass. This pressure increases continuously with increasing temperature, as raising the temperature releases the dissolved oxygen from the glass-ceramic. The temperature at which the oxygen partial pressure determined in this way reaches a value of 1 bar is referred to as T(pO₂=1 bar). The greater the amount of oxygen present in solution in a glass-ceramic, the lower the temperature T(pO₂=1 bar) at which an oxygen partial pressure of 1 bar is attained. T(pO₂=1 bar) is therefore a glass-ceramic property which indicates the amount of dissolved oxygen in the glass-ceramic.

If no reducing agents are used for producing the glass-ceramic, the temperature T(pO₂=1 bar) corresponds to the highest temperature attained during the melting and/or defining. If reducing agents are used, the temperature T(pO₂=1 bar) is higher than the highest temperature attained during the melting or refining.

In one development of the invention the glass-ceramic of the product has a temperature T(pO₂=1 bar) in the range from 1550° C. to 1700° C., preferably 1560° C. to 1690° C., more preferably in the 1570-1680° C. range. This temperature is a physical property of the glass-ceramic, and represents a measure of the oxygen dissolved in the glass-ceramic. The higher the value of the temperature T(pO₂=1 bar), the less oxygen is present in solution in the glass-ceramic.

Surprisingly it has emerged that beyond a temperature T(pO₂=1 bar) of more than 1550° C., the colouring effect of the MoO₃ is increased to an extent such that particularly little MoO₃ need be used in order to achieve a low luminous transmittance of less than 3.5%. Since MoO₃ is a comparatively expensive constituent of a glass-ceramic, this is particularly advantageous economically.

Preferably a temperature T(pO₂=1 bar) of more than 1700° C., more preferably more than 1690° C., very preferably more than 1680° C. ought to be avoided. Relatively high values for T(pO₂=1 bar) would require either the use of correspondingly high temperatures during melting, or the use of large amounts of reducing agents. Excessive temperatures at the melting stage, however, have adverse consequences for the service life of the melting tank, which would therefore have to undergo maintenance more frequently. Furthermore, both factors are economically disadvantageous, owing to the costs for energy and materials required.

Additions to the glass-ceramic of polyvalent components such as Fe₂O₃, MnO₂, V₂O₅, CeO₂ and TiO₂ have an influence on a large number of different properties of the glass-ceramic. For example, certain polyvalent components may have an inherent colour effect, while others may function as refining agents or influence the formation of the crystals. Some of them may also act simultaneously on two or more properties, such as Fe₂O₃, for example, which simultaneously provides colouring and influences the refining.

ZrO₂ as a component in the glass-ceramic is likewise advantageous for nucleation. For that purpose it is preferably in the glass-ceramic in amounts of 0.1%-2.5% by weight, more preferably 0.3%-2.0% by weight, very preferably 0.5%-1.5% by weight.

Surprisingly it has emerged that the ratio of ZrO₂ to TiO₂ has an influence not only on the nucleation but also on the temperature stability of the colour neutrality of the glass-ceramic. Glass-ceramics which contain ZrO₂ and TiO₂ in a ratio ZrO₂/TiO₂ of at least 0.1, preferably at least 0.15, more preferably at least 0.2 and at most 0.67, preferably at most 0.4, more preferably at 0.33 exhibit improved stability of the optical properties under thermal load. With a ratio chosen correspondingly it is even possible, for hobs with radiant heating elements, to reduce after-darkening, lightening or shifting of the colour locus in operation or even to rule out these phenomena very largely.

In other preferred embodiment, therefore, the glass-ceramic, generally or in combination with the preferred amounts of ZrO₂ and TiO₂ stated above, as a ratio of ZrO₂/TiO₂ in the range of 0.1-0.67, preferably 0.15-0.4 and more preferably 0.2-0.33.

It is advantageous, furthermore, if the glass-ceramic contains one or more of the following constituents in precisely defined amounts: V₂O₅, Cr₂O₃, Fe₂O₃.

Since V₂O₅ even in very small amounts produces a colour locus shift, it can be used accordingly in combination with the above-stated MoO₃ constituents to carry out fine-tuning of the colour locus. For this purpose the glass-ceramic may contain 0.0001%-0.010% by weight, preferably 0.0005%-0.0080% by weight, more preferably 0.0010%-0.0050% by weight of V₂O₅. V₂O₅ is typically present as an impurity in the glass-ceramic amounts of 1-15 ppm. Lower levels are achievable only with very high cost and effort and with raw materials purified by expensive procedures.

It has emerged that Cr₂O₃ has an addition to the glass-ceramics of the invention, even in very small amounts, has a strong influence on the colour locus, more particularly on the y-coordinate of the colour locus of the glass-ceramic in transmission. An addition of Cr₂O₃ produces a targeted increase in the value of the y-coordinate. For the fine-tuning of the colour locus, the glass-ceramic ma contain 0%-0.0100% by weight, preferably 0.0005%-0.0090%, more preferably 0.0010%-0.0060% by weight. Cr₂O₃ is generally present as an unavoidable impurity in the glass-ceramic in amounts of 1-5 ppm.

Furthermore, an unexpected interaction has emerged on simultaneous addition of V₂O₅ in combination with Cr₂O₃ in the amounts stated above. Through simultaneous addition of V₂O₅ and Cr₂O₃ it is possible for the x coordinate of the colour locus to be adjusted in a targeted way. The greater the amount of V₂O₅ and Cr₂O₃ present simultaneously in the glass-ceramic, the higher the value of the x coordinate. For this purpose the glass-ceramic may contain optionally V₂O₅+Cr₂O₃ from 0.001 to 0.010, preferably 0.002 to 0.008, more preferably 0.0025 to 0.0065.

Particularly good colour neutrality using MoO₃ as main colorant can be achieved preferably by the glass-ceramic containing MoO₃, V₂O₅ and Cr₂O₃ in a ratio (V₂O₅+Cr₂O₃)/MoO₃ in the range from at least 0.005 to 0.5, preferably from at least 0.01 to 0.2, more preferably from at least 0.03 to 0.15. Within this ratio range the influences of these three components balance out so as to result in a particularly colour-neutral glass-ceramic.

Furthermore, for the production of the glass-ceramics in continuous melting units, it has emerged as being particularly advantageous if the composition of the glass-ceramic fulfils the following condition: Li₂O+SnO₂<5.8, preferably <5.0, more preferably <4.5.

Fe₂O₃ has a strong influence on the transmission particularly in the near-infrared spectral range, and reduces the colouring effect of the MoO₃ in the visible spectral range. For fine tuning of the infrared transmission in particular, the glass-ceramic may contain 0.05%-0.3% by weight, preferably 0.06%-0.2% by weight, more preferably 0.07%-0.15% by weight of Fe₂O₃.

The MnO₂ component reduces the colouring due to MoO₃. The MnO₂ content is therefore preferably less than 0.5% by weight, more preferably less than 0.1% by weight or even less than 0.05% by weight. Since MnO₂ may have a supporting effect at the refining stage, it may be present in the glass-ceramic preferably in amounts of more than 0.001% by weight, preferably more than 0.005% by weight.

The glass-ceramics contain preferably 0%-0.4% of Nd₂O₃, more preferably 0%-0.2% by weight. The Nd₂O₃ content may more particularly be 0%-0.06% by weight. With particular preference no Nd₂O₃ is used and the glass-ceramic is technically free from Nd₂O₃, by unavoidable impurities. Impurities are generally present in that case at less than 10 ppm. With this colour oxide, the colour effect comes about via narrow absorption bands in the range at wavelengths of 526, 584 and 748 nm. Light in this wavelength range is absorbed more strongly on passage through the glass-ceramic.

A first preferred composition of the glass-ceramic for a product of the invention consists essentially, in % by weight based on an oxide, of:

Li₂O 1.0-5.5,

Al₂O₃ 16-26,

SiO₂ 58-72,

TiO₂ 2.0-<4.0,

ZrO₂ 0.1-2.5,

ZnO 0-<2.0,

SnO₂ 0.05-<0.7,

MoO₃ 0.005-0.12,

Fe₂O₃ 0.05-0.30,

Cr₂O₃ 0-0.0100,

V₂O₅ 0.0001-0.010.

In this composition it may be particularly advantageous to select the fraction of MoO₃ in the range 0.015%-0.100% by weight, preferably 0.020%-0.080% by weight and more preferably 0.030%-0.070% by weight and to select the other constituents in the ranges stated above.

Advantageous properties may be achieved in particular if the first preferred composition is selected within the following limits:

Li₂O 2.5-5

Al₂O₃ 18-24

SiO₂ 60-70,

TiO₂ 2.5-<4.0

ZrO₂ 0.3-2.0

ZnO 0.1-1.9

SnO₂ 0.06-<0.6

MoO₃ 0.015-0.100

Fe₂O₃ 0.06-0.20

Cr₂O₃ 0.0005-0.0090

V₂O₅ 0.0005-0.0080.

Particularly advantageous properties may be achieved in particular if the first preferred composition is selected within the following limits:

Li₂O 3-4.5

Al₂O₃ 19-23

SiO₂ 62-68

TiO₂ 2.8-3.9

ZrO₂ 0.5-1.5

ZnO 0.5-1.8

SnO₂ 0.07-<0.5

MoO₃ 0.020-0.080

Fe₂O₃ 0.07-0.15

Cr₂O₃ 0.0010-0.0060

V₂O₅ 0.0010-0.0050.

A second preferred composition of a glass-ceramic for a product of the invention consists essentially, in % by weight based on oxide, of the following:

Li₂O 1.0-5.5

ΣNa₂O+K₂O 0.1-<4

MgO 0-3

ΣCaO+SrO+BaO 0-5

ZnO 0-<2.0

B₂O₃ 0-3

Al₂O₃ 16-26

SiO2 58-72

TiO₂ 2.0-<4.0

ZrO₂ 0.1-2.5

SnO₂ 0.05-<0.7

P₂O₅ 0-4

MoO₃ 0.005-0.12

Fe₂O₃ 0.05-0.30

Nd₂O₃ 0-0.4

Cr₂O₃ 0-0.0100

MnO₂ 0-0.5

V₂O₅ 0.0001-0.0100.

A third preferred composition of a glass-ceramic for a product of the invention consists essentially, in % by weight based on oxide, of the following:

Li₂O 2.5-5

ΣNa₂O+K₂O 0.1-<3

MgO 0-2.8

ΣCaO+SrO+BaO 0-4

ZnO 0.1-1.9

B₂O₃ 0-3

Al₂O₃ 18-24

SiO₂ 60-70

TiO₂ 2.5-<4

ZrO₂ 0.3-2.0

SnO₂ 0.05-<0.6

P₂O₅ 0-4

MoO₃ 0.0015-0.1

Fe₂O₃ 0.06-0.20

Nd₂O₃ 0-0.2

Cr₂O3 0.0005-0.0090

MnO₂ 0.001-0.1

V₂O₅ 0.0005-0.0080.

A fourth preferred composition of a glass-ceramic for a product of the invention consists essentially, in % by weight based on oxide, of the following:

Li₂O 3-4.5

ΣNa₂O+K₂O 0.1-<3

MgO 0-2.8

ΣCaO+SrO+BaO 0-4

ZnO 0.5-1.8

B₂O₃ 0-3

Al₂O₃ 19-23

SiO₂ 60-68

TiO₂ 2.8-3.9

ZrO₂ 0.5-1.5

SnO₂ 0.05-<0.6

P₂O₅ 0-4

MoO₃ 0.020-0.080

Fe₂O₃ 0.007-0.15

Nd₂O₃ 0-0.06

Cr₂O₃ 0.0010-0.0060

V₂O₅ 0.0010-0.0050.

A fifth preferred composition of a glass-ceramic for a product of the invention consists essentially, in % by weight based on oxide, of the following:

SiO₂ 58-72

Al₂O₃ 16-26

Li₂O 1.0-5.5

TiO₂ 2.0-<4.0

ZnO 0-<2.0

MoO₃ 0.005-0.12,

ZrO₂/TiO₂ 0.1-0.67

(V₂O₅+Cr₂O₃)/MoO₃ 0.005-0.5

MoO₃/TiO₂ >0.002-<0.050

Li₂O+SnO₂ <5.8.

Advantageous properties may be achieved in particular if the fifth preferred composition is selected within the following limits:

SiO₂ 58-72

Al₂O₃ 16-26

Li₂O 1.0-5.5

TiO₂ 2.0-<4.0

ZnO 0-<2.0

MoO₃ 0.005-0.12

ZrO₂/TiO₂ 0.15-0.4

(V₂O₅+Cr₂O₃)/MoO₃ 0.01-0.2

MoO₃/TiO₂ >0.004-<0.040

Li₂O+SnO₂ <5.0.

Particularly advantageous properties may be achieved more particularly if the fifth preferred composition is selected within the following limits:

SiO₂ 58-72

Al₂O₃ 16-26

Li₂O 1.0-5.5

TiO₂ 2.0-<4.0

ZnO 0-<2.0

MoO₃ 0.005-0.12

ZrO₂/TiO₂ 0.2-0.33

(V₂O₅+Cr₂O₃)/MoO₃ 0.03-0.15

MoO₃/TiO₂ >0.008-<0.030

Li₂O+SnO₂ <4.5.

The indication “essentially consists of” means that the recited components are intended to amount to at least 96% by weight, preferably at least 98% by weight, of the total composition.

These glass-ceramics comprise, optionally, additions of chemical refining agents such as As₂O₃, Sb₂O₃ and CeO₂ and of refining additives such as manganese oxide, sulfate compounds and halide compounds (F, Cl, Br, I) in total amounts of up to 2.0% by weight. An example for halide compounds is the use of NaCl as a batch raw material for the introduction of Na.

For reasons of environmental and workplace safety, it is preferred where possible not to use toxic or objectionable raw materials. The glass-ceramic is therefore preferably free from environmentally harmful substances such as arsenic (As), antimony (Sb), cadmium (Cd), lead (Pb), caesium (Cs), rubidium (Rb), hafnium (Hf), halides and sulfur (S), except for unavoidable impurities in the range from preferably 0 to less than 0.5 per cent by weight, more preferably less than 0.1 per cent by weight, very preferably less than 0.05 per cent by weight. The figures in per cent by weight here are likewise based on the glass composition on an oxide basis.

Each of the stated preferred compositions one to four may additionally have a ratio MoO₃/TiO2 of 0.002-0.050, preferably 0.004-0.040, more preferably 0.008-0.030.

Each of the stated preferred compositions one to four may additionally or alternatively have a ratio ZrO₂/TiO₂ of 0.1-0.67, preferably 0.15-0.4, more preferably 0.2-0.33.

Each of the stated preferred compositions one to four may additionally or alternatively have a ratio (V₂O₅+Cr₂O₃)/MoO₃ of 0.005-0.5, preferably 0.01-0.2, more preferably 0.0.3-0.15.

Compounds of a multiplicity of elements such as, for example, the alkaline metal Rb or Cs or elements such as Mn and Hf are customary impurities in batch raw materials used industrially. Other compounds such as, for example, those of the elements B, Cl, F, W, Nb, Ta, Y, rare earths, Bi, Co, Cu, Cr and Ni may likewise be present as an impurity in batch raw materials used industrially, typically in the ppm range. 1000 ppm correspond to 0.1% by weight.

Further colouring constituents such as CoO, CuO or NiO may be present as long as they do not adversely affect the colouring of the glass-ceramic. Consequently the glass-ceramic contains preferably 0-250 ppm, preferably 0-100 ppm, more preferably 0-50 ppm of CoO and 0-250 ppm, preferably 0-100 ppm, more preferably 0-50 ppm of CuO and 0-250 ppm, preferably 0-100 ppm, more preferably 0-50 ppm of NiO. With further preference the glass ceramic, except for unavoidable impurities contains neither CoO nor CuO nor NiO. Typical impurities for these constituents are in the single-digit ppm range.

The production, generally speaking, may be carried out using either naturally occurring raw materials or chemically processed or synthetic produced raw materials, or mixtures of these. Naturally occurring raw materials are in general less costly than their chemically processed or synthesized counterparts. However, the possibility of using natural raw materials is limited by the typically high amounts of impurities. Examples of naturally occurring raw materials are quartz sand, spodumene and petalite. The amounts of impurities in these cases may differ very greatly depending on the type and the source of the raw materials. For example, both spodumene and petalite consist primarily of lithium oxide, aluminium oxide and silicon oxide. Because of the crystal structure and the geochemical peculiarities needed for the formation of spodumene and petalite respectively, spodumene contains significantly more iron oxide impurities than petalite. Furthermore, spodumenes from different mines or even from different batches from the same mine may contain a broad span of iron oxide impurities.

Chemically processed or synthetically produced raw materials generally contain only very few impurities. Moreover, these impurities are relatively constant. Accordingly they fluctuate between different batches only to a very small extent. This is advantageous for the planning of the glass batch for the melt, since there is virtually no need to compensate fluctuations between batches. Examples of customary processed or synthesized raw materials are lithium carbonate or titanium dioxide powder.

The impurities due to typical trace elements in the technical raw materials used are customarily up to 200 ppm B₂O₃, 30 ppm Cl, 1 ppm CoO, 3 ppm Cr₂O₃, 200 ppm Cs₂O, 3 ppm CuO, 200 ppm F, 400 ppm HfO₂, 3 ppm NiO, 500 ppm Rb₂O, 1-15 ppm V₂O₅.

Preferably the thickness of the glass-ceramic is 1 to 15 mm, preferably 2 to 10 mm, more preferably 3 to 6 mm. The thickness of approximately 4 mm has developed to become a de facto standard for numerous applications such as hobs, stove sight glasses or baking-oven doors, and is therefore of very great economic importance.

The glass-ceramic may be smooth on both sides. Smooth here means in particular that it may have a flat rolled, floated or polished surface. The advantage of a glass-ceramic smooth on both sides is that luminous displays can be perceived through the glass-ceramic with particularly absent distortion. Alternatively the glass-ceramic may also have a knubbed structure on the side facing away from the utility side. For example, glass-ceramic hobs frequently have a knubbed structure on their underside, which contributes to increasing the mechanical robustness. The utility side in this context is that side of the glass-ceramic that faces the user of the product. In the case of a hob, this is the upper side.

In the case of knubbed glass-ceramics, there may be a coating of a transparent material on the melt side. The refractive index of the material ought to be very close indeed to the refractive index of the glass-ceramic in the visible wavelength range from 380 nm to 780 nm. At a wavelength of 550 nm it ought preferably to differ by not more than 0.2, more preferably not more than 0.1, from the refractive index of the glass-ceramic. An illustrative material having these qualities is silicone resin. Silicone resins preferably used in unpigmented form in order to maximise the transmission. As and when required, however, pigments or dyes may also be added, if the desire for the colouring of the coating for an optical scattering effect. The coating may fill up the valleys between the knubs at least partly, preferably completely. By way of its immersion effect, a coating of this kind may reduce or even level out the optical distortion of transmitted light resulting from the lens effect of the knubs.

Alternatively a transparent film may be adhered to the knubs, which likewise compensates the optical distortion. Films suitable for this purpose are transparent and have a temperature stability sufficient for the use. The refractive index of the film of a wavelength of 550 nm ought preferably to differ from that of the glass-ceramic by not more than 0.2, more preferably not more than 0.1. Examples of suitable films are those of polycarbonate which are adhered to the knubbed side of the glass-ceramic by means of an acrylate adhesive, more particularly in the form of an acrylate film. On account of their high transmission and thermal stability, polycarbonate films adhered using acrylate adhesives are especially suitable for display regions of hobs. Other examples of suitable films are films of polyethylene, polyester or polyethylene naphthalate. These films as well may be secured to the glass-ceramic by means of acrylate adhesive, more particularly by means of acrylate film. The use of other adhesives is also possible, more particularly of other adhesive films. Suitability is possessed in principle by any adhesive which adheres to glass and plastic surfaces, is transparent and has a temperature stability sufficient for the use. At a wavelength of 550 nm the refractive index of the adhesive ought to differ from that of the glass-ceramic by not more than 0.2, more preferably not more than 0.1. Alternative adhesives that can be used include, for example, silicone adhesives.

As an alternative, instead of the film, it is also possible to use thin glass or ultra-thin glass. In the case of films made of polymers, the adhesive, irrespective of the nature of the adhesive, may partly or fully fill the nub valleys. In the case of thin glass or ultra-thin glass, the adhesive ought to fully fill the nub valleys, since glasses, unlike films made of polymers, are unable to conform to the shape of the nubs.

In one development of the invention the product may also have optical filters in order, for example, to adapt the colour locus of luminous displays. It is conceivable for example in one operating unit to use multiple white light sources, especially LEDs, which differ in construction and hence in light colour. In that case the light colour of the different light sources can be adapted to one another by means of targeted filters.

Other colour filters as well may be provided in the product, in order, for example, to generate luminous phenomena outside the white region Al when using luminous elements whose light, after passage through the glass-ceramic without colour filters, lies within the white region A1. For example, after transmission through such a colour filter and the glass-ceramic, white light may be turned into colour light—for example, blue, red or green light or light with virtually any desired other colour. Such colour filters preferably have a C* of more than 0.08, preferably more than 0.16, more preferably more than 0.24, in order to be able to represent colours with particularly high colour chroma.

Filters of these kinds may be present for example in the form of layers applied by printing or otherwise, or plates or films applied by pressing or laminating. Filters in the form of layers may be produced by means of customary processes. These include, for example, printing, more particularly screen, flexographic and inkjet printing, slot die coating, knife coating, and vacuum coating processes, more particularly plasma CVD and sputtering. Filters may be laminated, printed or applied to the glass-ceramic either directly, or indirectly to a carrier such as a film or plate, which is then placed between luminous entity and glass-ceramic.

In one preferred embodiment the product, additionally to the glass-ceramic, has a means for reducing the luminous transmittance. Such a means may be, in particular, a coating applied to the glass-ceramic, and adhered or pressed-on film or an adhered or pressed-plate. With particular preference such a means is arranged on the side of the glass-ceramic facing away from the user in the context of the intended usage.

A means of this kind for reducing the luminous transmittance has, together with the glass-ceramic, a luminous transmittance of less than 0.5%, preferably less than 0.1%, more preferably less than 0.01% or even of less than 0.001%. When the means takes the form of a metal foil, especially foils made of aluminium, having a thickness of at least 100 μm, for example, luminous transmittances of significantly less than 0.001% may also be achieved. Low transmission values of this kind are also achievable with coatings based on sol-gel, silicone or enamel with corresponding pigmentation and layer thickness. Sputtered layers as well, made of metals such as aluminium, silver or stainless steel, for example, may have a correspondingly low transmission at sufficient layer thickness.

A means of this kind for reducing the luminous transmittance preferably has at least one cutout through which light is able to be passed. A cutout of this kind may form a window for a luminous display, for example. Alternatively such a cutout may take the form, for example, of a symbol, character, letter, geometric forms or a number. When such a cutout is backlit with a luminous element, the result is then that the user of the product perceives a luminous symbol, for example, which is perceptible weakly or not at all when the luminous element is switched off. This improves the operational safety, since the user is always able to perceive activated characters and symbols well, and hence there is no risk of confusion with non-activated characters or symbols.

If the means for reducing the luminous transmittance takes the form of a coating, such a cutout may either be not provided with such a coating from the outset, or the coating may be subsequently removed again at this point. This may be accomplished, for example, by laser, more particularly by means of CO₂ laser or ultra-short pulse laser. The removal may also take place wet-chemically. When films or plates are being used, for example, a cutout may be generated by cutting out the corresponding parts of the film or plate.

Aside from cutouts, a means for reducing the luminous transmittance may be disposed over the full area or only on partial areas of the cover means. In order to achieve particularly high reduction of the luminous transmittance, two or more of these means may also be arranged directly or indirectly one after another.

In a further preferred embodiment the product has at least one diffuser. In the course of use as intended, a diffuser is disposed on the side of the product or the glass-ceramic that faces away from the viewer. A diffuser here is a means which has a luminous transmittance of at least 10% and on account of its structure is capable of converting directed light passing through the diffuser at least proportionally into diffuse light, by optical scattering.

Diffusers may take the form, for example, of coatings, films or plates. The light scattering may be caused, for example, by suitably sized particles present in the coating, film or plate. Such particles may have a size, for example, which is in the order of magnitude of the wavelength of visible light or below it. Furthermore, such particles have a refractive index which differs from the refractive index of the surrounding coating, film or plate. Such particles may for example consist of or comprise TiO₂ With particular preference the particles are homogeneously distributed spatially in the coating, film or plate.

The scattering effect of a diffuser may alternatively be achieved, for example, by way of a region with sufficiently high roughness on the surface of the glass-ceramic, a coating, a film or a plate. A surface with high roughness may be produced, for example, by means of abrasive processes such as sandblasting or via etching operations. Sufficiently high roughness in this context means a mean roughness Rₐ of between 100 nm and 10 μm, preferably between 200 nm and 2 μm, more preferably between 500 nm and 1 μm.

The effect of a diffuser of this kind is that light from a luminous element directed onto the diffuser generates a substantially homogeneous lighting appearance. This is the case in particular for luminous elements having pointwise lighting means such as LEDs.

A diffuser may also be arranged in particular in the region of the cutout of a means for reducing the luminous transmittance. There it may overlap partially or completely with the cutout. An advantage of this is that when the cutout is lit through with a lighting element, it can be illuminated particularly homogeneously.

In the case of a combination of a diffuser with a means for reducing the luminous transmittance, the diffuser may be arranged, for example, between the glass-ceramic and the means, between the means and a luminous element, or between two means for reducing luminous transmittance. In that case it may also overlap in each case with the one or more means for reducing. If arranged between two means for reducing, the two means must have overlapping cutouts and the diffuser must be arranged at least partially in the region of the overlap.

The product may have further coatings on the glass-ceramic. These include, for example, decorative coatings, layers for marking particular regions, texts, symbols, anti-scratch layers, anti-reflection layers, refractive layers, electrically conductive layers, layers for increasing the infrared reflection, layers for improving cleanability, anti-glare layers, anti-fingerprint layers, antimicrobial layers or combinations thereof. Depending on implementation, such layers may be arranged on one side or on both sides of the glass-ceramic, over the full area or on partial areas. Such coatings may alternatively be individual layers or stacks of multiple layers arranged above or behind one another.

In one preferred embodiment the product may have or be combined with a multiplicity of different lighting systems. Such lighting systems may be used, for example, for decorative lighting or to generate luminous displays. They may employ a multiplicity of different technical lighting solutions. They may for example have LEDs, OLEDs, laser diodes, projectors, optical waveguides, pixel-based displays, particularly LCD or AM-OLED, segment displays, more particularly 7-segment displays, and/or pointwise, near or extensive luminous elements. The light elements may have a single unchangeable light colour. They may alternatively permit changeable light colours, mixed changes made up of light in different colours, more particularly red, green and/or blue, or may emit spectrally broad light, more particularly white light. Spectrally broad light emission refers to an emission spectrum having a Full Width Half Maximum (FWHM) of more than 50 nm.

### BRIEF DESCRIPTION OF THE DRAWINGS

The invention is elucidated in more detail with reference to the figures.

FIG. 1 shows the black-body curve (“BBC”), the chromaticity coordinates of light of the standard illuminant D65 on direct viewing without glass-ceramic, “D65”), the position of the white regions A1 and A2, and the chromaticity coordinates of light of the standard illuminant D65 after the passage through a glass-ceramic of Examples 1-16 (“Ex. 1-16”) in a detail of the CIE chromaticity diagram in the CIExyY colour space.

FIG. 2 shows the same data as FIG. 1 for the overview of the position, but not in a detail, but instead with representation of the entire CIExyY colour space.

FIG. 3 shows the relationship between the resistivity and the frequency of the alternating current for different temperatures. The measurements were performed on a glass-ceramic according to Example 17.

FIG. 4 shows the relationship between the relative permittivity and the frequency of the alternating current for different temperatures. The measurements were performed on a glass-ceramic according to Example 17.

FIG. 5 shows the relationship between the loss factor and the frequency of the alternating current for different temperatures. The measurements were performed on a glass-ceramic according to Example 17.

FIG. 6 shows the relationship between the relative permittivity and the temperature of the glass-ceramic for an alternating current frequency of 1.9 GHz and 5.1 GHz. The measurements were performed on a glass-ceramic according to Example 17.

FIG. 7 shows the relationship between the loss factor and the temperature of the glass-ceramic for an alternating current frequency of 1.9 GHz and 5.1 GHz. The measurements were performed on a glass-ceramic according to Example 17.

FIG. 8 shows the relationship between the relative permittivity and the temperature of the glass-ceramic for an alternating current frequency of 1 MHz, 1.9 GHz and 5.1 GHz. The measurements were performed on a glass-ceramic according to Example 17.

FIG. 9 shows the relationship between the loss factor and the temperature of the glass-ceramic for an alternating current frequency of 10 KHz, 100 KHz, 1 MHz, 1.9 GHz and 5.1 GHz. The measurements were performed on a glass-ceramic according to Example 17.

FIG. 10a shows the spectral transmittance of a glass-ceramic of the invention (reference symbol 1) at a thickness of 4 mm in the wavelength range of 380 nm to 780 nm. Additionally FIG. 10a shows the spectral transmittance of the same glass-ceramic with an additional anti-scratch layer (reference symbol 2) at a thickness of 4 mm in the wavelength range 380 nm to 780 nm.

FIG. 10b shows the same data as FIG. 10a, but in the wavelength range 250-2500 nm.

### DETAILED DESCRIPTION

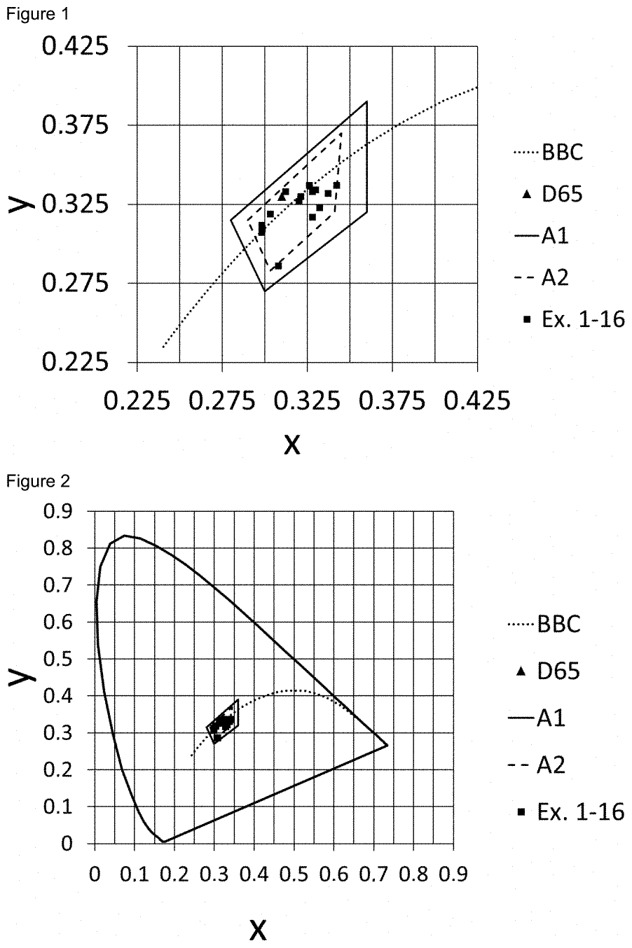

The black-body curve BBC in FIGS. 1 and 2 shows the colour locus of the light emitted by a black-body radiator at different radiator temperatures on direct viewing (without glass-ceramic). Since the sun is a black-body radiator, light whose colour locos lies on the curve BBC is perceived to be particularly white, natural and pleasing.

Light of the standard illuminant D65 on direct viewing (without glass-ceramic) lies at the colour coordinates x=0.3127, y=0.3290. When D65 standard light passes through an absorbing glass-ceramic, the colour locus of the light may shift as a result of the absorption of the glass-ceramic. D65 standard light corresponds approximately to a black-body radiator having a temperature of approximately 6500 K.

For all of Examples 1 to 17, the colour locus of light of the standard illuminant D65 on passage through a corresponding sample is shifted only minimally along the BBC. Examples 1 to 4 lie almost exactly on the BBC. For all of the examples of the colour locus lies within the region A1. Examples 1 to 4 also lie within A2. Example 5 lies slightly below the BBC and just outside A2. Accordingly all of the examples have a very colour-neutral behaviour with respect to transmitted light. Colour shifts are only minimal.

Examples 1 to 17 are elucidated in more detail with Table 1. Examples 1 to 17 are glass-ceramic suitable for use in products of the invention. Comparative Example V1 is a glass-ceramic which does not conform to the invention.

The crystallisable starting glasses of the examples from Table 1 were produced in plants for the industrial production of LAS glass-ceramics. Sources of knowledge about melting operations for the industrial production of LAS glass-ceramics include EP 2 226 303 A2 and “Allgemeine Technologie des Glases, Grundlagen des Schmelzens and der Formgebung” [General Glass Technology, Principles of Melting and of Shaping], Prof. Dr H. A. Schaeffer, Erlangen, September 1985. The crystallisable starting glasses are also referred to below as green glass or green glasses.

Production took place using batch raw materials customary in the industry; for example:

| Constituent | Customary raw materials |
|---|---|
| Al₂O₃ | Spodumene, petalite, aluminium trihydroxide |
| BaO | Barium carbonate |
| CaO | Dolomite, calcium feldspar |
| Fe₂O₃ | Iron oxide, spodumene |
| K₂O | Potassium feldspar, potassium nitrate |
| Li₂O | Spodumene, petalite, lithium carbonate |
| MgO | Magnesite, dolomite |
| Na₂O | Sodium feldspar, sodium nitrate, sodium chloride |
| SiO₂ | Quartz sand, spodumene, petalite |
| SnO₂ | Tin oxide |
| TiO₂ | Rutile, synthetic titanium dioxide |
| V₂O₅ | Vanadium oxide |
| ZnO | Zinc oxide |
| ZrO₂ | Zirconium silicate |

The melting unit used was a continuously operated hybrid tank with oxyfuel burners and electrical additional heating. Likewise conceivable, however, is the use of a continuously operating all-electric tank or an exclusively fossil-heated tank as the melting unit. In the case of fossil-heated tanks, the fuel employed may alternatively be a mixture of fossil fuel and hydrogen, or hydrogen-based fuel without a fossil component. The use of synthetic fuels is also conceivable.

Designation “continuously operating” here means that batch is supplied continuously to the melting unit at one end and molten glass is withdrawn continuously at the opposite end.

Contrasting with these are discontinuously operating melting units. In the case of discontinuous operating units, the batch is introduced into a sufficiently cold crucible. The crucible is heated, and so the batch is melted and a glass melt is formed. The glass melt is subsequently poured from the crucible and subjected to hot shaping. When the crucible is sufficiently cooled again, it can be filled again with batch and a new melting operation performed. Therefore glass can be removed only discontinuously (batchwise) from a unit of this kind.

The specific melting performance of a unit indicates the number of metric tons of glass that can be produced on a daily basis, based on the base area of the unit. It is reported in units of metric tons per square metre per day (i.e. t/(m² d).

The base area of the unit is a product of the distance between the inlet for the batch at the front end and the distributor at the rear end of the unit, in other words the total length of the glass melt in the unit, and also the width of the glass melt in the unit. A unit having a width of 8 m and a length of 15 m defined in this way has a base area of 120 m², for example. Units having base areas of between around 50 and 250 m² are commonplace for the production of glass-ceramic.

Another factor effecting the specific melting performance is the way in which the unit is operated. The hotter it is operated, the quicker the progress of thermal operations such as melting and refining in the glass melt. Consequently larger amounts of glass can be withdrawn from the unit at higher temperatures.

Where a unit is operated with a very low specific melting performance, the economics of the production operation are impaired. On operation with a very high specific melting performance, there is a risk of the high throughput having adverse effect on glass quality. This may be the case, for example, if the glass melt has such a short residence time in the unit that melting processes cannot take place completely or there is not sufficient time available for refining.

Glass-ceramics of the invention can be produced for example in units having a specific melting performance of 0.3 t/(m² d) to 1.5 t/(m² d), preferably 0.4 to 1.2 t/(m² d), more preferably 0.5 to 1.1 t/(m² d).

Surprisingly, glass-ceramics produced in a continuously operating melting unit having a specific performance of at least 0.3 t/(m² d) and at most 1.5 t/(m² d), especially in relation to glass-ceramics melted discontinuously in crucibles, exhibit improved properties such as a particularly good colour neutrality and a reduced requirement for colouring components in the composition of the glass-ceramic.

The produced observed for the examples from Table 1 was as follows:

Provision of the batch and introduction into the tank. To improve the melting behaviour, shards from the closed shard circuit of the tank or optionally from recycling circuits are typically added to the batch.

### MELTING OF THE BATCH

Defining of the glass melt at glass melt temperatures of at least 1550° C., preferably 1600° C., more preferably 1650° C. The upper limit on the refining temperature is generally dependant on the temperature stability of the tank materials. The refining temperature is typically below 1850° C., preferably below 1800° C., more preferably below 1750° C. At temperatures of more than 1700° C. it is generally necessary for additional high-temperature refining units to be used. This means an additional energy expenditure for production, but in certain circumstances this can be competitive as a result of a greater specific melting performance and an improved glass quality.

Cooling of the glass melt to temperatures at which hot shaping, such as rolling, for example, is possible.

Implementation of hot shaping, for example rolling to a glass strip thickness of 4 mm, for example.

### COOLING TO ROOM TEMPERATURE SEPARATION INTO INDIVIDUAL PLATES, AND STACKING

The examples from Table 1 were produced with a specific melting performance of 1 t/(m² d). The examples were each produced in the form of rectangular plates having dimensions of 520×590×4 mm.

The water content of crystallisable glasses produced in this way for the production of the glass-ceramics is preferably between 0.01 and 0.09 mol/l, depending on the choice of the batch raw materials and the operating conditions at the melting stage. The method of determining water content is described for example in EP 1074520 A1. The water content can be adapted to the choice of the batch raw materials and the operating conditions.

The samples 1-17 are ceramised with a ceramisation process in a continuous furnace, with the following steps:

a) heating from room temperature to 740° C. at a heating rate of 30 K/min,
b) temperature increase from 740 to 825° C. at a heating rate of 6 K/min,
c) temperature increase from 825° C. to 930° C. at a heating rate of 18 K/min,
d) hold time of 6 min at 930° C. maximum temperature,
e) cooling to 800° C. at a cooling rate of 13 K/min, then rapid cooling to room temperature by discharge of the sample from the furnace.

The samples 18-24 are ceramised with a ceramisation process in a continuous furnace, with the following steps:

a) heating from room temperature to 740° C. at a heating rate of 30 K/min,
b) temperature increase from 740 to 825° C. at a heating rate of 6 K/min,
c) temperature increase from 825° C. to 930° C. at a heating rate of 15 K/min,
d) hold time of 6 min at 926° C. maximum temperature,
e) cooling to 800° C. at a cooling rate of 12 K/min, then rapid cooling to room temperature by discharge of the sample from the furnace.

It is known that the temperatures value, hold times and heating rates during ceramisation can be adapted, starting from the example given above, in order to optimise the properties of the resultant glass-ceramic. In particular it may be advantageous to select higher heating/cooling rates than those in the example indicated. The heating/cooling rates ought, however, not to be below the following values: 20 K/min in step a), 2 K/min in step b), 8 K/min in step c), and cooling at a cooling rate of at least 8 K/min in step d). Higher rates, as well as influencing the physical properties, are beneficial to the cycle times of the ceramisation process. The temperature in step d) may be varied for example in the range 890-940° C.

In practice the heating rates actually achievable are dependant both on the geometry/thermal mass of the plates for the ceramised, and on the heating units available.

Plates ceramised in this way may have a glassy, amorphous and lithium-depleted superficial zone at their surface. Such zones are known for example from WO 2012 019 833 A1. They improve the resistance of the glass-ceramic to chemical attacks. The glassy zone has a thickness of between 20 and 5000 nm, preferably of between 30 and 3000 nm, more preferably of between 50 and 1500 nm. By polishing it is possible to remove the glassy zone from a glass-ceramic surface after ceramisation.

The impurities caused by typical trace elements in the case of the technical raw materials used were—unless otherwise specified—up to 200 ppm B₂O₃, 30 ppm Cl, 1 ppm CoO, 3 ppm Cr₂O₃, 200 ppm Cs₂O, 3 ppm CuO, 200 ppm F, 400 ppm HfO₂, 3 ppm NiO, 500 ppm Rb₂O, 5 ppm V₂O₅.

Table 1 shows the composition of Examples 1 to 17 and of Comparative Example V1 and also certain selected properties after the ceramisation. Baring customary impurities, the examples contain no Sb₂O₃ and As₂O₃. All examples contain MoO₃ in the corresponding amounts as main colorant.

Comparative Example V1 was produced in a discontinuous process, rather than by the process described above in a continuous melting unit like Examples 1 to 17. The crystallisable starting glass was melted in each case from technical batch raw materials customary in the glass industry at temperatures of 1620° C., in 4 hours. After the melting of the batch in a crucible made of sintered silica glass, the melts were poured into Pt/Rh crucibles with an inner silica glass crucible and homogenized by stirring at temperatures of 1600° C., for 60 minutes. Following this homogenisation, the glass was refined at 1640° C. for 2 hours. Subsequently pieces with a size of around 120×140×30 mm³ were cast and were cooled to room temperature beginning from 640° C. in a cooling oven into dissipate stresses. The castings were divided into the sizes needed for the studies and for the ceramisation. The ceramisation took place by the process described above, which was also used to ceramise Examples 1 to 17.

In spite of the relatively high MoO₃ content of 0.11% by weight, the comparison example has a luminous transmittance of more than 4% at a thickness of 4 mm. As a result of this high luminous transmittance, the poorer opacity of this glass-ceramic makes it unsuitable for use in products of the invention. The comparison example, furthermore, has an undesirably high ZnO fraction, of more than 2% by weight.

The comparative example has a temperature T(pO₂=1 bar) of less than 1550° C. It therefore contains a relatively large amount of oxygen dissolved in the glass-ceramic. By comparison with this, Examples 1-5 have higher temperatures T(pO₂=1 bar), in the range of 1592° C.-1633° C. They therefore contain less dissolved oxygen than Comparative Example V1.

Examples 1 to 17 contain 7 to 35 ppm V₂O₅ and 10 to 41 ppm Cr₂O₃. Accordingly, as is evident from FIG. 1, it is possible to establish the colour locus of transmitted light of the standard illuminant D65 at a desired value very precisely within the white region A1. The Comparative Example V1 contains neither V₂O₅ nor Cr₂O₃.

Table 1 lists the spectral transmittances at different wavelengths in the visible and near-infrared spectral range. All values reported are based on a glass-ceramic thickness of 4 mm. The values provide evidence of the advantageous transmission profile for the products of the invention, with low transmission in the visible spectral range from 380 to 780 nm and high transmission in the near infrared from 780 to 4000 nm. A profile of this kind makes the glass-ceramic suitable for producing cover plates which prevent viewing through the plate yet transmit thermal radiation or IR radiation for optical communication or sensor technology.

With these values as well it is apparent that the transmission of Comparative Example V1 at the specified wavelengths if significantly higher than that of Examples 1 to 17.

The colour coordinates in the CIExyY colour space (1931, 2°) of light of the standard illuminant D65 after passage through a sample 4 mm in thickness are likewise listed in Table 1. The Y coordinate is identical to the luminous transmittance τᵥᵢₛ according to DIN EN 410.

For the examples a determination was made of the thermal expansion in the 20° C. to 700° C. temperature range. All of the examples have values of significantly less than 1×10⁻⁶/K. On the basis of this low expansion, these glass-ceramics are particularly suitable for use in products such as hobs, for example, which are subject to high temperature change loads or high local temperature gradients.

Through x-ray diffraction it was possible to confirm all of the examples as comprising high-quartz solid solution (“HQSS”) as main crystal phase. This is also apparent from the fact that at a thickness of 4 mm the examples exhibited virtually no scattering acceptable to the naked eye for visible light.

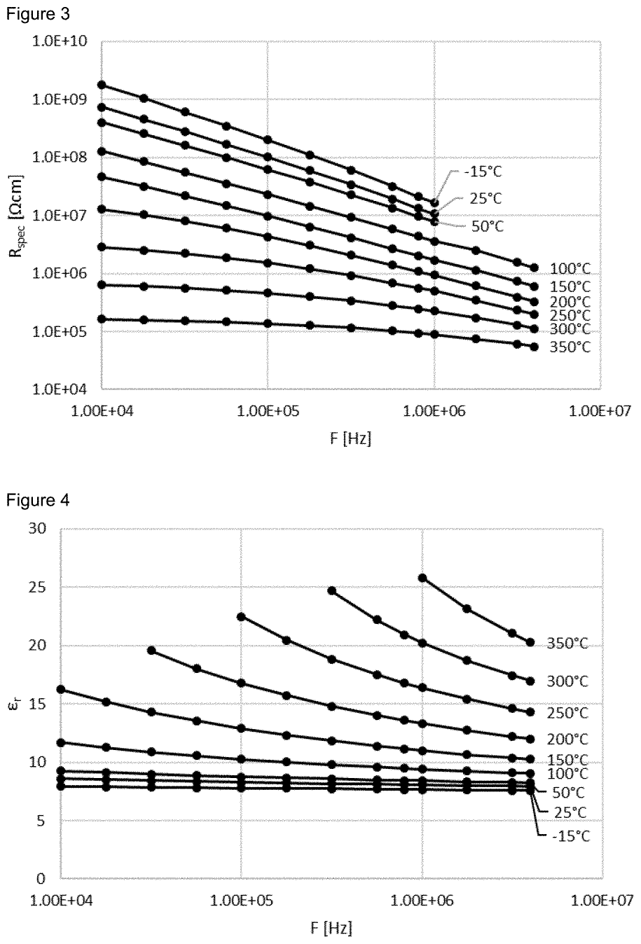

The electrical properties of the glass-ceramics were studied representatively for all the examples on the basis of Example 17. The results are set out in FIGS. 3 to 9. The glass-ceramics exhibit electrical properties typical of LAS glass-ceramics. The resistivity for electrical current, R_{spec}, decreases as the temperature of the glass-ceramic goes up. In addition the resistivity for alternating current goes down as the frequency of the alternating current goes up. In this regard, FIG. 3, illustratively, shows measurement data for the resistivity, recorded for temperatures from −15° C. to 350° C. and for frequencies from 10 KHz to 40 MHz. The values extend over more than 4 powers of ten, from 5.5*10⁴ Ω cm to 1.8*10⁹ Ω cm. This can presumably be explained by an altered mobility of charge carriers in the glass-ceramic under the corresponding conditions.

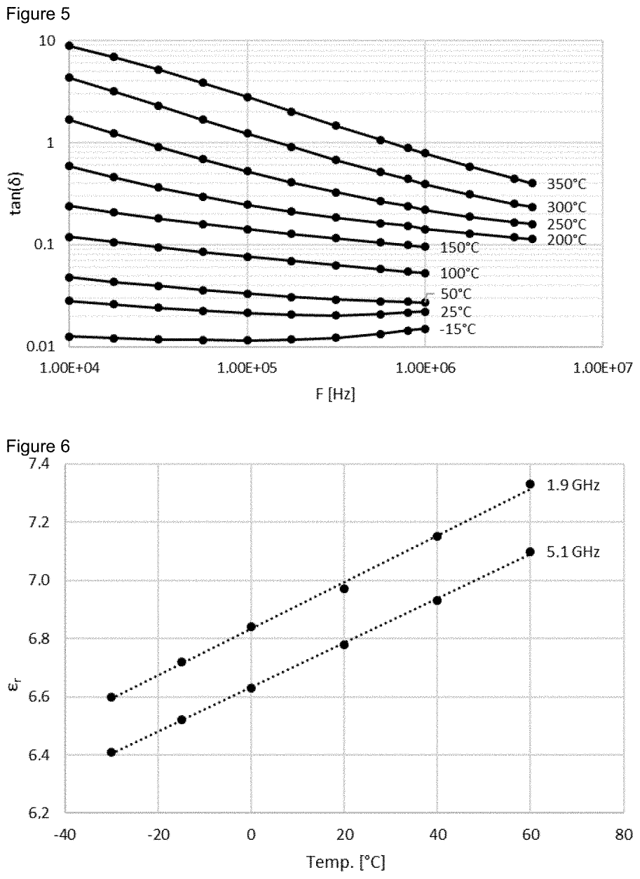

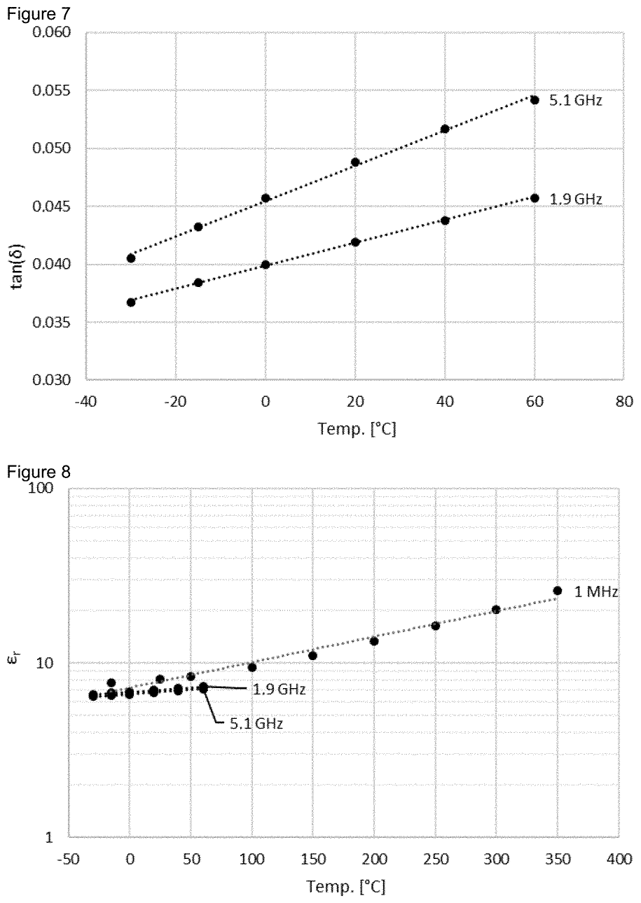

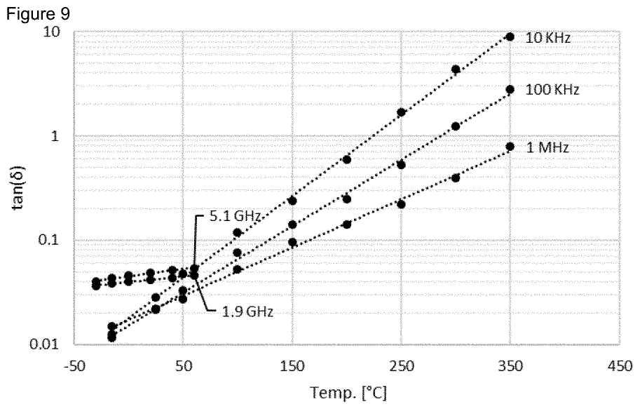

Accordingly, for alternated electrical voltages which may be present in particular between the upper side and the lower side of the glass-ceramic, there are also changes in the electrical properties of the glass-ceramic. These properties, quantified here with measurements of the parameters of the relative permittivity ϵᵣ and the loss factor tan (δ) of the glass-ceramic, are represented illustratively in FIGS. 4 to 9 as a function of the frequency of the applied alternating voltage and of the temperature of the glass-ceramic. FIGS. 4 and 5 show the frequency dependency of the relative permittivity and the loss factor for various temperatures occurring in particular in cooking applications of a glass-ceramic hob, over a frequency range from 10 KHz to 40 MHz. FIGS. 6 and 7 show the temperature dependency of the relative permittivity and the loss factor for the frequencies 1.9 GHz and 5.1 GHz. These frequencies are illustrative of a frequency range which is important in microwave heating applications or in wireless signal networks, such as WLAN/WiFi. FIGS. 8 and 9 likewise show the temperature dependencies as in FIGS. 6 and 7, extended to include illustrative frequencies from the 10 KHz to 40 MHz range and here to include a temperature range of up to 350° C. which is typical in specifically of cooking applications.

Alternating electrical voltages may find technical applications as a measurement signal or else for power transmission. In particular in the frequency range from 10 KHz to 40 MHz, in metrology, for example, capacitive touch sensors or else capacitive or incaptive temperature measurements, owing in particular to the temperature dependency of the electrical properties, may be provided. An important factor for touch sensors in particular is the relative permittivity at room temperature. The values for the relative permittivity here illustratively at 25° C., in the range 7.9 to 8.3, are stable over a relevant frequency range from 10 KHz to 40 MHz (FIG. 4). The glass-ceramics are especially suitable for capacitive touch sensors because the relative permittivity exhibits significantly higher values than for other materials with typically lower relative permittivities. Reference is for comparison include plastics (2-4), natural substances such as wood or paper (1-4), or glass (about 6-7).

The temperature dependency of the relative permittivity and of the loss factor (FIGS. 8 and 9), which is strongly pronounced particularly in the lower frequency range (10 KHz to 40 MHz), can be utilized for example for capacitive or inductive temperature measurements. A capacitive temperature measurement may be developed, for example, between a sensor electrode beneath the glass-ceramic and the base of a pan above the glass-ceramic. The relative permittivity which is relevant for capacitive measurements changes here, illustratively, between 25° C. and 350° C. from 8.1 to 25.8 by a factor of about 3, and this can be converted in a known way into an electrical signal change. In just the same way, the loss factor changing over the temperature can be utilized by an inductive temperature measurement. For example, the transmission loss between an emitting coil beneath the glass-ceramic and a sensor coil in a cooking vessel above the glass-ceramic changes at a signal frequency of 10 KHz between 25° C. and 350° C. from 0.03 to 8.9 by a factor of about 300, or between 50° C. and 150° C. from 0.05 to 0.25 by a factor of 5. A sensor coil beneath the glass-ceramic would also, via its self-induction, be sensitive to the temperature-dependent change in the electrical properties of the glass-ceramic material in its vicinity.

The temperature-dependent changes in the loss factor are also relevant for inductive heating, as is found, for example, in induction hobs. Typical operating frequencies here are between 10 KHz and 100 KHz. An increase in the loss factor with the temperature in this frequency range (FIG. 9) leads to a decrease in the power transmission into the cooking vessel and/or to a measurable increase in the power loss in the resident circuit of the inductive heating. This can also be utilized indirectly for a temperature measurement at the cooking vessel.

Further applications in which a part is played in particular by the loss factor in the context of power transmissions for different frequencies are inductive charging equipment for mobile terminal devices on hob plates or worktops made from glass-ceramic, or else applications in the field of electromobility. Also subject to the electrical properties in the manner described illustratively above are galvanically isolated signal transmissions through glass-ceramic which is used as a partition wall and protective wall in areas insulated and protected biological, chemically or physically (radiation).

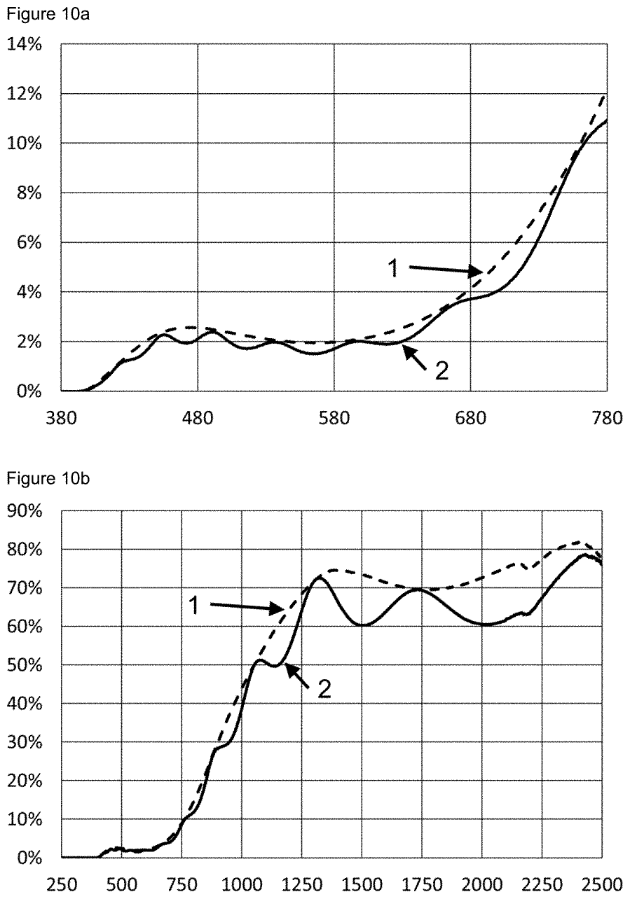

As a further working example, a 4 mm glass ceramic according to Example 17 was coated with an anti-scratch layer. The layer was produced by means of reactive moderate-frequency sputtering as described in WO 2014/135490 A1. The coating is an x-ray-amorphous AlSiN layer with an Al:Si ratio of 50:50 at %. The layer thickness is about 1200 nm. FIGS. 10a and 10b are plots, for comparison, of the spectral transmittances of the uncoated glass-ceramic (reference symbol 1) and of the glass-ceramic with coating (reference symbol 2) against the wavelength of the light in nm. In comparison to the uncoated glass-ceramic, there is only an interference modulation of the transmission from the substantially transparent coating. As a result, the luminous transmittance is lowered slightly. The lowering amounts to around 8% in relative terms, corresponding to an absolute lowering of around 0.2%. The colour locus of light of the standard illuminant D65 is altered by the coating only to so small an extent that the change is imperceptible to the naked eye. The colour difference in the transmitted light can be calculated by the following formula:

ΔC=\sqrt{(x_{GK}−x_{GK+S})²+(y_{GK}−y_{GK+S})²}.

In this formula, x_{GK}/y_{CK} are the colour coordinates of light of the standard illuminant D65 after passage through the uncoated glass-ceramic (here: x_{GK}=0.3184, y_{GK}=0.3270), and x_{GK+S}/y_{GK+S} are the colour coordinates after passage through the glass-ceramic with coating (here: x_{GK+S}=0.3202, y_{GK+S}=0.3284). For the coating shown in FIG. 3, accordingly, ΔC is only 0.002 and is therefore imperceptible to the human eye.

For comparison, again, reference may be made to the colour coordinates of light of the standard illuminant D65 when viewed directly, in other words without a glass-ceramic: x=0.3127, y=0.3290. In this case, therefore, the colour of light of the standard illuminant D65 is not markedly shifted either by the glass-ceramic on its own or by the combination of glass-ceramic with anti-scratch coating.

Products of the invention can be used in a multiplicity of applications.

In one embodiment of the product of the invention can be used in cooking appliance as a cooking plate.

In another embodiment a product of the invention may be used for covering a user interface in a control panel for controlling at least one household appliance, more particularly a cooking appliance, baking oven or refrigerator or an extractor hood.

In one development of this embodiment, the control panel may be configured for controlling multiple household appliances, such as for a cooking appliance, a baking oven and an extractor hood, for example. An extractor hood may also be integrated in the form of a downdraft extractor hood into a cooking appliance having a corresponding glass-ceramic cooking plate. For this purpose the product or the glass-ceramic may then have a cutout into which the downdraft extractor hood can be inserted. In a further embodiment the product may be designed as a cover for an extractor hood, more particularly a downdraft extractor hood. In modular cooking systems in particular, downdraft extractor hoods may be designed as a separate module without a cooking function. Since, however, such modules must be suitable for use in combination with modules having a cooking function, they are likewise required to meet the customary, very exactly requirements in terms of thermal and chemical stability. Furthermore, such modules may also have a user interface for the control of the downdraft remover. For user interfaces of this kind as well, the objective stated above in terms of colour-neutral displays must be fulfilled.

In a further embodiment, the product may be designed as the facing of an extractor group. In this embodiment it may be particularly aesthetic appealing if the hob of the cooking appliance and the facing of the extractor hood feature the same glass-ceramic. This embodiment is particularly advantageous if the extractor hood features a user interface arranged behind the glass-ceramic for controlling the extractor hood, or a user interface for the combined control of the extractor hood and the cooking appliance.

In baking ovens, especially pyrolysis ovens, the product of the invention will be used as part of door glazing.

In a further embodiment the product of the invention may be used in item of kitchen furniture, more particularly a kitchen cabinet, in a cooking table, as a worktop.

In another embodiment a product of the invention may be used as a splash protection plate for kitchens. Hence it may be used, for example, in the form of a plate as the back wall of a kitchen, in place of a tile mirror, for example. It may also be provided as a free-standing splash protection plate on a kitchen island. A splash protection plate of this kind may either be permanently installed, or have a recessible design. Recessible splash protection plates can be extended for the operation of a cooking appliance, to act as splash protection. After the end of cooking, they can then be recessed, for example, in the cooking appliance or in the worktop. In this case it may be particularly appealing aesthetically if both the cooking plate of the cooking appliance and the splash protection plate feature the same glass-ceramic of a product of the invention. The kitchen worktop additionally may likewise contain the same glass-ceramic.

Splash protection plates for kitchens are regularly splashed during cooking with hot liquids such as salt water or animal or vegetable fat. They are regularly cleaned with chemical cleaning products as well. Given the high thermal and chemical stability of products of the invention, they are especially suitable for use as a splash protection plate for kitchens.

In another embodiment a product of the invention may be used in a laboratory appliance, more particularly a hotplate, an oven, a balance or an item of laboratory furniture, more particularly an extractor, a cabinet or a bench, for covering a user interface or as a worktop.

In another embodiment a product of the invention may be used as a stove sightgIasses for combustion chambers and other high-temperature process chambers, as fire resistant glazing, as part of a housing for mobile electronic devices, especially mobile phones and tablet computers, as a cover for IR heating lamps or gas burners, especially in gas grills, as a privacy screen or as a cover for induction charging stations, for example for motor vehicles/automobiles, for example in the dashboard region or the centre console.

On the basis of its thermal chemical stability, the product in these context can be used in stoves both for interiors and for the exterior area. Such stoves may be fired for example with gas, wood or pellets.

High-temperature process chambers may for example be vacuum coating systems.

In grill appliances, there may be diverse possible uses for a product of the invention. It may be used to provide a protective cover for gas burners, concealing the gas burners in the switched-off state but revealing the flame in the switched-on state. As the colour of the flame is an important indicator for the proper operation of the grill, a true-colour representation of the kind possible with the present product is particularly advantageous for operational safety.

The product may be used, furthermore, as a grilling surface, particularly in gas, electric or charcoal grills, or as a viewing window in the hood of a grill.

TABLE 1
Examples of glass-ceramics for products of the invention

| | | | | | | |
|---|---|---|---|---|---|---|
| Example | 1 | 2 | 3 | 4 | 5 | V1 |

Composition (wt %)

| | | | | | | | |
|---|---|---|---|---|---|---|---|
| Al₂O₃ | wt % | 21.29 | 21.29 | 21.25 | 21.24 | 21.16 | 21.24 |
| BaO | wt % | 1.31 | 1.32 | 1.32 | 1.32 | 1.33 | 1.19 |
| CaO | wt % | 0.44 | 0.44 | 0.441 | 0.438 | 0.436 | 0.55 |
| Cr₂O₃ | wt % | 0.0041 | 0.0024 | 0.0024 | 0.0023 | 0.001 | 0 |
| Fe₂O₃ | wt % | 0.091 | 0.092 | 0.091 | 0.090 | 0.098 | 0.070 |
| K₂O | wt % | 0.41 | 0.41 | 0.41 | 0.41 | 0.40 | 0.57 |
| Li₂O | wt % | 3.78 | 3.76 | 3.78 | 3.77 | 3.80 | 3.45 |
| MgO | wt % | 0.31 | 0.30 | 0.31 | 0.30 | 0.30 | 0.35 |
| MnO₂ | wt % | 0.021 | 0.021 | 0.021 | 0.021 | 0.021 | 0.01 |
| MoO₃ | wt % | 0.052 | 0.055 | 0.055 | 0.054 | 0.068 | 0.11 |
| Na₂O | wt % | 0.56 | 0.57 | 0.56 | 0.56 | 0.56 | 0.52 |
| P₂O₅ | wt % | 0.052 | 0.052 | 0.052 | 0.054 | 0.052 | 0 |
| SiO₂ | wt % | 65.21 | 65.19 | 65.22 | 65.25 | 65.26 | 65.55 |
| SnO₂ | wt % | 0.28 | 0.28 | 0.28 | 0.28 | 0.28 | 0.25 |
| SrO | wt % | 0.0073 | 0.0073 | 0.0074 | 0.0075 | 0.0096 | 0 |
| TiO₂ | wt % | 3.64 | 3.64 | 3.65 | 3.65 | 3.66 | 3.41 |
| V₂O₅ | wt % | 0.0023 | 0.0007 | 0.0008 | 0.0009 | 0.0035 | 0 |
| ZnO | wt % | 1.58 | 1.59 | 1.58 | 1.58 | 1.58 | 2.12 |
| ZrO₂ | wt % | 0.90 | 0.91 | 0.91 | 0.91 | 0.92 | 1.05 |

Spectral transmittance at 4 mm thickness

| | | | | | | | |
|---|---|---|---|---|---|---|---|
| 470 nm | % | 1.7 | 2.5 | 2.4 | 2.4 | 1.2 | 5.4 |
| 600 nm | % | 1.5 | 1.7 | 1.6 | 1.6 | 0.8 | |
| 700 nm | % | 4.1 | 4.0 | 3.9 | 4.0 | 2.9 | |
| 950 nm | % | 35.0 | 33.7 | 33.5 | 33.7 | 33.1 | 46.6 |
| 1600 nm | % | 70.0 | 69.6 | 69.6 | 69.9 | 67.8 | 73.8 |

Transmittance at 4 mm thickness

| | | | | | | | |
|---|---|---|---|---|---|---|---|
| Y | % | 1.5 | 1.8 | 1.7 | 1.7 | 0.8 | 34.1 |

Colour coordinates in transmission at 4 mm thickness

| | | | | | | |
|---|---|---|---|---|---|---|
| x | 0.330 | 0.299 | 0.298 | 0.298 | 0.308 | 0.305 |
| y | 0.334 | 0.310 | 0.308 | 0.307 | 0.286 | 0.297 |

dissolved oxygen

| | | | | | | | |
|---|---|---|---|---|---|---|---|
| T (pO2 = 1 bar) | ° C. | 1633 | 1608 | 1592 | 1604 | 1610 | 1543 |

Density

| | | | | | | |
|---|---|---|---|---|---|---|
| glassy | g/cm³ | 2.46 | 2.46 | 2.46 | 2.46 | 2.46 |

| | | | | | | |
|---|---|---|---|---|---|---|
| Example | 6 | 7 | 8 | 9 | 10 | 11 |

Composition (wt %)

| | | | | | | | |
|---|---|---|---|---|---|---|---|
| Al₂O₃ | wt % | 21.24 | 21.29 | 21.29 | 21.29 | 21.29 | 21.29 |
| BaO | wt % | 1.31 | 1.31 | 1.31 | 1.31 | 1.31 | 1.31 |
| CaO | wt % | 0.44 | 0.44 | 0.44 | 0.44 | 0.44 | 0.44 |
| Cr₂O₃ | wt % | 0.0031 | 0.0025 | 0.0035 | 0.0035 | 0.0025 | 0.0035 |
| Fe₂O₃ | wt % | 0.089 | 0.089 | 0.089 | 0.094 | 0.089 | 0.089 |
| K₂O | wt % | 0.43 | 0.41 | 0.41 | 0.41 | 0.41 | 0.41 |
| Li₂O | wt % | 3.74 | 3.74 | 3.74 | 3.74 | 3.74 | 3.74 |
| MgO | wt % | 0.30 | 0.31 | 0.31 | 0.31 | 0.31 | 0.31 |
| MnO₂ | wt % | 0.020 | 0.021 | 0.021 | 0.021 | 0.021 | 0.021 |
| MoO₃ | wt % | 0.048 | 0.046 | 0.046 | 0.059 | 0.051 | 0.046 |
| Na₂O | wt % | 0.56 | 0.56 | 0.56 | 0.56 | 0.56 | 0.56 |
| P₂O₅ | wt % | 0.021 | 0.052 | 0.052 | 0.052 | 0.052 | 0.052 |
| SiO₂ | wt % | 65.27 | 65.21 | 65.21 | 65.21 | 65.21 | 65.21 |
| SnO₂ | wt % | 0.28 | 0.28 | 0.28 | 0.28 | 0.28 | 0.28 |
| SrO | wt % | 0.01 | 0.0073 | 0.0073 | 0.0073 | 0.0073 | 0.0073 |
| TiO₂ | wt % | 3.64 | 3.64 | 3.64 | 3.64 | 3.64 | 3.64 |
| V₂O₅ | wt % | 0.0017 | — | — | — | — | 0.0026 |
| ZnO | wt % | 1.58 | 1.58 | 1.58 | 1.58 | 1.58 | 1.58 |
| ZrO₂ | wt % | 0.90 | 0.90 | 0.90 | 0.90 | 0.90 | 0.90 |

Transmittance at 4 mm thickness

| | | | | | | | |
|---|---|---|---|---|---|---|---|
| Y | % | 2.3 | 2.87 | 2.53 | 1.96 | 2.31 | 2.24 |

Colour coordinates in transmission at 4 mm thickness

| x | | 0.320 | 0.303 | 0.312 | 0.328 | 0.298 | 0.326 |
|---|---|---|---|---|---|---|---|
| y | | 0.327 | 0.319 | 0.333 | 0.333 | 0.312 | 0.337 |
| Example | 12 | 13 | 14 | 15 | 16 | 17 | |

Composition (wt %)

| | | | | | | | |
|---|---|---|---|---|---|---|---|
| Al₂O₃ | wt % | 21.29 | 21.29 | 21.29 | 21.29 | 21.29 | 21.34 |
| BaO | wt % | 1.31 | 1.31 | 1.31 | 1.31 | 1.31 | 1.31 |
| CaO | wt % | 0.44 | 0.44 | 0.44 | 0.44 | 0.44 | 0.44 |
| Cr₂O₃ | wt % | 0.0025 | 0.0035 | 0.0035 | 0.0025 | 0.0035 | 0.0033 |
| Fe₂O₃ | wt % | 0.094 | 0.094 | 0.089 | 0.094 | 0.094 | 0.092 |
| K₂O | wt % | 0.41 | 0.41 | 0.41 | 0.41 | 0.41 | 0.41 |
| Li₂O | wt % | 3.74 | 3.74 | 3.74 | 3.74 | 3.74 | 3.76 |
| MgO | wt % | 0.31 | 0.31 | 0.31 | 0.31 | 0.31 | 0.30 |
| MnO₂ | wt % | 0.021 | 0.021 | 0.021 | 0.021 | 0.021 | 0.021 |
| MoO₃ | wt % | 0.046 | 0.046 | 0.051 | 0.051 | 0.051 | 0.054 |
| Na₂O | wt % | 0.56 | 0.56 | 0.56 | 0.56 | 0.56 | 0.57 |
| P₂O₅ | wt % | 0.052 | 0.052 | 0.052 | 0.052 | 0.052 | 0.052 |
| SiO₂ | wt % | 65.21 | 65.21 | 65.21 | 65.21 | 65.21 | 65.16 |
| SnO₂ | wt % | 0.28 | 0.28 | 0.28 | 0.28 | 0.28 | 0.28 |
| SrO | wt % | 0.0073 | 0.0073 | 0.0073 | 0.0073 | 0.0073 | 0.0073 |
| TiO₂ | wt % | 3.64 | 3.64 | 3.64 | 3.64 | 3.64 | 3.64 |
| V₂O₅ | wt % | 0.0026 | 0.0026 | 0.0026 | 0.0026 | 0.0026 | 0.0015 |
| ZnO | wt % | 1.58 | 1.58 | 1.58 | 1.58 | 1.58 | 1.59 |
| ZrO₂ | wt % | 0.90 | 0.90 | 0.90 | 0.90 | 0.90 | 0.91 |

Spectral transmittance at 4 mm thickness

| | | |
|---|---|---|
| 470 nm | % | 2.6 |
| 600 nm | % | 2.1 |
| 700 nm | % | 5.2 |
| 950 nm | % | 37.4 |
| 1600 nm | % | 71.3 |

Transmittance at 4 mm thickness

| | | | | | | | |
|---|---|---|---|---|---|---|---|
| Y | % | 1.97 | 1.73 | 1.8 | 1.59 | 1.4 | 2.1 |

Colour coordinates in transmission at 4 mm thickness

| | | | | | | |
|---|---|---|---|---|---|---|
| x | 0.332 | 0.342 | 0.321 | 0.328 | 0.337 | 0.318 |
| y | 0.323 | 0.337 | 0.330 | 0.317 | 0.332 | 0.327 |

Density

| ceramized | g/cm³ | | | | | | 2.54 |
|---|---|---|---|---|---|---|---|
| Example | 18 | 19 | 20 | 21 | 22 | 23 | |

Composition (wt %)

| | | | | | | | |
|---|---|---|---|---|---|---|---|
| Al₂O₃ | wt % | 21.27 | 21.27 | 21.35 | 21.28 | 21.57 | 21.52 |
| BaO | wt % | 1.32 | 1.31 | 1.33 | 1.32 | 1.32 | 1.33 |
| CaO | wt % | 0.44 | 0.44 | 0.44 | 0.44 | 0.44 | 0.44 |
| Cr₂O₃ | wt % | 0.003 | 0.0032 | 0.0032 | 0.003 | 0.0031 | 0.0031 |
| Fe₂O₃ | wt % | 0.092 | 0.093 | 0.093 | 0.091 | 0.092 | 0.092 |
| K₂O | wt % | 0.42 | 0.41 | 0.42 | 0.42 | 0.41 | 0.4 |
| Li₂O | wt % | 3.76 | 3.75 | 3.75 | 3.75 | 3.75 | 3.73 |
| MgO | wt % | 0.3 | 0.31 | 0.3 | 0.31 | 0.3 | 0.3 |
| MnO₂ | wt % | 0.011 | 0.011 | 0.011 | 0.011 | 0.011 | 0.011 |
| MoO₃ | wt % | 0.063 | 0.061 | 0.059 | 0.059 | 0.057 | 0.058 |
| Na₂O | wt % | 0.57 | 0.57 | 0.57 | 0.58 | 0.56 | 0.55 |
| P₂O₅ | wt % | 0.061 | 0.058 | 0.064 | 0.059 | 0.066 | 0.066 |
| SiO₂ | wt % | 65.3 | 65.27 | 65.21 | 65.25 | 64.98 | 65.02 |
| SnO₂ | wt % | 0.27 | 0.27 | 0.27 | 0.27 | 0.27 | 0.27 |
| SrO | wt % | 0.013 | 0.014 | 0.009 | 0.009 | 0.015 | 0.015 |
| TiO₂ | wt % | 3.59 | 3.63 | 3.62 | 3.68 | 3.68 | 3.68 |
| V₂O₅ | wt % | | 0.0017 | 0.0016 | 0.0016 | 0.0015 | 0.0013 |
| ZnO | wt % | 1.56 | 1.56 | 1.57 | 1.57 | 1.57 | 1.57 |
| ZrO₂ | wt % | 0.96 | 0.97 | 0.93 | 0.9 | 0.9 | 0.9 |

Spectral transmittance at 4 mm thickness

| | | | | | | | |
|---|---|---|---|---|---|---|---|
| 470 nm | % | 2.6 | 2.4 | 2.5 | 2.0 | 2.6 | 2.6 |
| 600 nm | % | 2.2 | 2.0 | 2.1 | 1.6 | 2.2 | 2.1 |
| 700 nm | % | 5.7 | 5.3 | 5.5 | 4.2 | 5.3 | 5.2 |
| 950 nm | % | | | | | | |
| 1600 nm | % | 69.8 | 69.7 | 69.9 | 69.5 | 70.1 | 69.9 |

Transmittance at 4 mm thickness

| | | | | | | | |
|---|---|---|---|---|---|---|---|
| Y | % | 2.2 | 2.0 | 2.1 | 1.6 | 2.2 | 2.2 |

Colour coordinates in transmission at 4 mm thickness

| | | | | | | |
|---|---|---|---|---|---|---|
| x | 0.325 | 0.324 | 0.323 | 0.318 | 0.319 | 0.316 |
| y | 0.328 | 0.327 | 0.327 | 0.322 | 0.325 | 0.325 |

Density

| | | | | | | | |
|---|---|---|---|---|---|---|---|
| glassy | g/cm³ | 2.45 | 2.45 | 2.46 | 2.45 | 2.46 | 2.46 |
| ceramized | g/cm³ | 2.54 | 2.54 | 2.54 | 2.54 | 2.54 | 2.54 |

| | |
|---|---|
| Example | 24 |

Composition (wt %)

| | | |
|---|---|---|
| Al₂O₃ | wt % | 21.23 |
| BaO | wt % | 1.33 |
| CaO | wt % | 0.44 |
| Cr₂O₃ | wt % | 0.003 |
| Fe₂O₃ | wt % | 0.092 |
| K₂O | wt % | 0.41 |
| Li₂O | wt % | 3.76 |
| MgO | wt % | 0.3 |
| MnO₂ | wt % | 0.01 |
| MoO₃ | wt % | 0.059 |
| Na₂O | wt % | 0.54 |
| P₂O₅ | wt % | 0.05 |
| SiO₂ | wt % | 65.37 |
| SnO₂ | wt % | 0.27 |
| SrO | wt % | 0.014 |
| TiO₂ | wt % | 3.61 |
| V₂O₅ | wt % | 0.0018 |
| ZnO | wt % | 1.57 |
| ZrO₂ | wt % | 0.94 |

Spectral transmittance at 4 mm thickness

| | | |
|---|---|---|
| 470 nm | % | 2.8 |
| 600 nm | % | 2.5 |
| 700 nm | % | 6.4 |
| 950 nm | % | |
| 1600 nm | % | 70.1 |

Transmittance at 4 mm thickness

| | | |
|---|---|---|
| Y | % | 2.5 |

Colour coordinates in transmission at 4 mm thickness

| | |
|---|---|
| x | 0.328 |
| y | 0.331 |

Density

| | | |
|---|---|---|
| glassy | g/cm³ | 2.45 |
| ceramized | g/cm³ | 2.54 |

What is claimed is:

1. A product comprising a transparent, volume-coloured glass-ceramic, where the glass-ceramic comprises, in % by weight based on oxide:
SiO₂ 58-72,
Al₂O₃ 16-26,
Li₂O 1.0-5.5,
TiO₂ 2.0-<4.0,
ZnO 0-<2.0,
MoO₃ 0.005-0.12,
wherein the glass-ceramic, based on a thickness of 4 mm, has a luminous transmittance τᵥᵢₛ of 0.5%-3.5%, and
wherein the glass-ceramic has a property that after passage through the glass-ceramic, based on a thickness of 4 mm, light of the standard illuminant D65 has a colour locus in the white region A1 that in the CIExyY-2° chromaticity diagram is defined by the following coordinates:
A1

| | |
|---|---|
| 0.3 | 0.27 |
| 0.28 | 0.315 |
| 0.35 | 0.38 |
| 0.342 | 0.31 |
| 0.3 | 0.27. |

2. The product of claim 1, wherein the luminous transmittance τᵥᵢₛ is 1.2%-2.8%.

3. The product of claim 1, wherein the glass-ceramic comprises MoO₃, in % by weight based on oxide, of 0.030-0.070.

4. The product of claim 1, wherein the glass-ceramic further comprises a temperature T(pO₂32 1 bar) in a range 1550-1700° C.

5. The product of claim 1, wherein the glass-ceramic further comprises a temperature T(pO₂=1 bar) in a range 1570-1680° C.

6. The product of claim 1, wherein the glass-ceramic comprises TiO₂, in % by weight based on oxide, of 3.0-3.8.

7. The product of claim 1, wherein the glass-ceramic further comprises ZrO₂, in % by weight based on oxide, of 0.1-2.5.

8. The product of claim 1, wherein the glass-ceramic further comprises ZrO₂, in % by weight based on oxide, of 0.5-1.5.

9. The product of claim 1, wherein the glass-ceramic further comprises ZrO₂ and has a ZrO₂/TiO₂ ratio in a range of 0.1-0.67.

10. The product of claim 1, wherein the ZrO₂/TiO₂ ratio is a range of 0.2-0.33.

11. The product of claim 1, where the glass-ceramic further comprises a constituent selected from a group consisting of: V₂O₅ in an amount of 0.0001-0.010 in % by weight based on oxide, V₂O₅ in an amount of 0.0005-0.0080 in % by weight based on oxide, V₂O₅ in an amount of 0.0010-0.0050 in % by weight based on oxide, Cr₂O₃ in an amount of 0-0.0100 in % by weight based on oxide, Cr₂O₃ in an amount of 0.0005-0.0090 in % by weight based on oxide, Cr₂O₃ in an amount of 0.0010-0.0060 ppm, Fe₂O₃ in an amount of 0.05-0.30 in % by weight based on oxide, Fe₂O₃ in an amount of 0.06-0.20 in % by weight based on oxide, Fe₂O₃ in an amount of 0.07-0.15 in % by weight based on oxide, and combinations thereof.

12. The product of claim 1, wherein the glass-ceramic has a thickness between 1 to 15 mm.

13. The product of claim 1, wherein the glass-ceramic further comprises V₂O₅ and Cr₂O₃ and has a (V₂O₅+Cr₂O₃)/MoO₃ ratio in a range from at least 0.005 to 0.5.

14. The product of claim 1, wherein the glass-ceramic further comprises V₂O₅ and Cr₂O₃ and has a (V₂O₅+Cr₂O₃)/MoO₃ ratio in a range from at least 0.03 to 0.15.

15. The product of claim 1, wherein the glass-ceramic has a MoO₃/TiO₂ ratio between 0.002 and 0.050.

16. The product of claim 1, wherein the glass-ceramic has a MoO₃/TiO₂ ratio between 0.008 and 0.030.

17. The product of claim 1, wherein the glass-ceramic further comprises SnO₂ and wherein Li₂O+SnO₂<5.8.

18. The product of claim 1, wherein the glass-ceramic further comprises SnO₂ and wherein Li₂O+SnO₂<4.5.

19. The product of claim 1, wherein the glass-ceramic has a property that after passage through the glass-ceramic, based on a thickness of 4 mm, light of the standard illuminant D65 has a colour locus in the white region A2 which in the CIExyY-2° chromaticity diagram is defined by the following coordinates:
A2

| X | y |
|---|---|
| 0.290 | 0.315 |
| 0.345 | 0.370 |
| 0.341 | 0.320 |
| 0.303 | 0.283 |
| 0.290 | 0.315. |

20. The product of claim 1, wherein the product is configured for a use selected from a group consisting of a cooking appliance, a baking oven, a kitchen furnishing, a splash panel for a kitchen, an internal or external lining of stove, a viewing window of a stove, a grill, a refrigerator, a microwave appliance, a cover or facing of an extractor hood, a mobile phone, a tablet computer, a motor vehicle, a laboratory appliance, a laboratory furnishing, a fire protection glazing, a viewing window for a high-temperature process chamber, an IR emitter cover, a privacy screen, a cover of a user interface in a control panel, and a cover for an induction charging station.
